(19) United States
(12) Patent Application Publication
(10) Pub. No.: US 2026/0139938 A1
(43) Pub. Date: May 21, 2026

(54) DISTANCE DETECTION DEVICE, DISTANCE DETECTION METHOD, AND PROCESSING DEVICE

(71) Applicant: SHENZHEN HINGIN TECHNOLOGY CO., LTD., SHENZHEN (CN)

(72) Inventors: JING LIN, SHENZHEN (CN); GUANGYU LIN, SHENZHEN (CN)

(21) Appl. No.: 19/393,776

(22) Filed: Nov. 19, 2025

(30) Foreign Application Priority Data
Nov. 20, 2024 (CN) 202411666341.2

(51) Int. Cl. G01B 7/14; B23K 26/035; B23K 26/364

(52) U.S. Cl. CPC G01B 7/14; B23K 26/037; B23K 26/364

(57) ABSTRACT

A distance detection device, a distance detection method, and a processing device are provided. The processing device includes a processing head configured to process a workpiece and the distance detection device detechably connected to the processing head. The distance detection device is configured to detect a height of a processing surface of the workpiece. The processing head is configured to process the processing surface of the workpiece according to the height of the processing surface of the workpiece. When external forces in the same direction are applied to a probe shaft of the distance detection device, the probe shaft is extendable and retractable. In this way, no specific reset position is needed, and the probe shaft is extendable and retractable at different positions. The probe shaft is allowed to directly reset along a Z-axis direction without resetting in an X-axis and a Y-axis.

### TECHNICAL FIELD

The present disclosure relates to a technical field of distance detection, and in particular to a distance detection device, a distance detection method, and a processing device.

### BACKGROUND

Distance detection devices play a crucial role in many fields. For example, a distance detection devices may be mounted on a mobile platform or a stationary platform for remote sensing, obstacle avoidance, surveying, modeling, etc. The distance detection devices are also applied in workpiece processing, such as laser engraving and laser marking. A conventional distance detection device is operated by applying a downward force to an upper portion of a probe thereof to release the probe, and applying an upward force to a bottom portion of the probe to retract the probe after completing focusing on a detected distance. It's clear that the forces extending and retracting the probe are not in the same direction. The area below the probe is a working area, and obstacles are not allowed to be disposed in the working area. Therefore, when the upward force is applied to the bottom portion of the probe to retract the probe, the probe must be outside the working zone; otherwise, the processing surface of the workpiece may be damaged. Consequently, after each distance detection, the distance detection device must move outside the working zone to retract the probe, resulting in cumbersome detection steps and wasted detection time.

Electromagnetic detection is also adopted. A principle of electromagnetic detection is that simply energizing a detection assembly allows the probe to extend and retract. A disadvantage of electromagnetic detection is that an extension time of the probe is relatively short (2-3 seconds). After 2-3 seconds, the probe overheats and is unable to extend further, so the probe retracts directly, resulting in incomplete detection of a multi-point curved surface of the workpiece. Furthermore, the longer the probe extends, the larger and more expensive the detection assembly becomes.

### SUMMARY

In the prior art, a conventional distance detection device is operated by applying a downward force to an upper portion of a probe thereof to release the probe, and applying an upward force to a bottom portion of the probe to retract the probe after completing focusing on a detected distance. It's clear that the forces extending and retracting the probe are not in the same direction. An area below the probe is a working area, and obstacles are not allowed to be disposed within the working area. Therefore, when the upward force is applied to the bottom portion of the probe to retract the probe, the probe must be outside the working zone; otherwise, the processing surface of the workpiece may be damaged. Consequently, after each distance detection, the distance detection device must move outside the working zone to retract the probe, resulting in cumbersome detection steps and wasted detection time.

To solve defects in the prior art, the present disclosure provides a distance detection device, a distance detection method, and a processing device. The distance detection device comprises a housing, a pressing shaft, and a detector. A through hole is defined in a lower end of the housing. The pressing shaft and a detector are disposed in the housing. The pressing shaft is movable along a length direction of the pressing shaft. A slider is connected to a lower end of the pressing shaft. The slider moves along with the pressing shaft to push the detector to move. The detector passes through the through hole to move along a length direction of the detector. The housing defines preset positions, and when external forces in the same direction are applied to the distance detection device, the slider moves in the housing to different preset positions to change a length of the detector extending out of the housing.

The detector is a probe or a probe shaft. The detector is pushed to move by applying a vertical downward force to the pressing shaft to move the pressing shaft in the length direction thereof and push the slider to move, then the slider moves to one of the preset positions and is relatively fixed. At this time, an extension length of the detector is a maximum extension length that needs to be extended. At the same time, the pressing shaft continues to apply a vertical downward force to move the pressing shaft to another one of the preset positions. The length of the detector extending out of the housing is changed by applying different external forces to the detector, so as to realize a distance detection of a processing surface. After the distance detection is completed, the detector returns to the maximum extension length for re-detection, so that repeated detection is realized.

Optionally, elastic pieces are disposed in the housing. The elastic pieces are deformed under an action of the slider. The slider is capable of moving to different preset positions in the housing under the external forces applied to the distance detection device and a force of the elastic pieces, so as to change the length of the detector extending out of the housing.

By providing the elastic pieces, the elastic pieces are compressed when the slider moves, and a restoring force is provided for the slider to return to an initial position when the elastic pieces reset, so that the slider and the detector are enabled to return to initial positions each time, and detection accuracy is improved.

Optionally, at least one preset groove is defined in the housing. The preset positions are formed in the at least one preset groove. The distance detection device further comprises a positioning piece movable in the at least one preset groove. When the slider moves, the positioning piece is movable to different preset positions in the housing, the length of the detector extending out of the housing is fixed or variable.

The at least one preset groove is defined inside the housing, and the at least one preset groove defines different preset positions. When the slider is in different preset positions, the extension length of the probe is the same or not exactly the same. As mentioned above, the extension length of the probe is the maximum when the slider is placed in one of the preset positions. Since the preset positions are different, the maximum extension length is variable. It is convenient to move the slider to different preset positions to change the maximum extension length of the probe, so as to adapt to a maximum distance of different processing surfaces to the distance detection device, which has a wide range of applications.

Optionally, the preset positions comprise high points, low points, and intermediate points. The high points, the intermediate points and the low points are sequentially disposed in the at least one preset groove. The intermediate points are disposed between the low points and the high points. The at least one preset groove is disposed in a loop.

The slider extends to different high points, low points, and intermediate points corresponding to different extension lengths. In some embodiments, when the slider is at one of the high points, the probe extends to have a small extension length, while in other embodiments, the probe extends to have a large extension length. A situation where the slider is at one of the low points is the opposite of that at the one of the high points. Because the at least one preset groove is disposed in the loop, the slider is allowed to cyclically move between the high points, the intermediate points, and the low points to realize cyclic movement of the probe under the action of the external forces in the same direction of the distance detection device.

Optionally, the positioning piece is disposed in the at least one preset groove, the slider and the positioning piece interact with each other. When the slider moves, a position of the positioning piece in the at least one preset groove is changed. When the positioning piece is placed at any one of the preset positions of the at least one preset groove, the position of the slider is relatively fixed.

The slider is relatively fixed by connecting the positioning piece to the at least one preset groove, which facilitates shape configurations of the at least one preset groove. The positioning piece is easy to assemble, making it easy to assemble and disassemble the positioning piece and improving applicability of the positioning piece.

Optionally, the positioning piece is a probe hook. A first end of the probe hook is connected to the housing. A second end of the probe hook is a movable end, the at least one preset groove is disposed on the slider. The movable end of the probe hook moves in the at least one preset groove of the slider to change a relative position between the detector and the slider.

The first end of the probe hook is fixed inside the housing. The movable end of the probe hook slides in the at least one preset groove to adjust the preset positions of the probe hook in the at least one preset groove. After the probe hook is connected to one of the preset positions, the housing and the slider are relatively fixed to adjust the extension length of the probe. After applying pressure to the pressing assembly, the movable end of the probe hook moves in the at least one preset groove to make sliding of the slider smoother, a connection thereof more stable, and the operation more convenient.

Optionally, the positioning piece is an engaging tooth disposed on the housing. The at least one preset groove is defined in the slider and is corresponding to the engaging tooth. The engaging tooth is capable of being placed at different preset positions of the at least one preset groove to change a position of the detector.

Optionally, the slider comprises a pressing rod and a locking piece. A lower end of the pressing rod defines pressing rod slopes. An upper end of the locking piece defines locking piece slopes corresponding to the pressing rod slopes. The pressing rod slopes of the pressing rod are movable to generate a rotational force on the locking piece slopes of the locking piece to cause the slider to move and change a position of the engaging tooth relative to the at least one preset groove, so as to change the position of the detector.

The pressing rod slope of the pressing rod moves to generate the rotational force on the locking piece slope of the locking piece to cause the locking piece to rotate horizontally or move vertically. When the locking piece moves vertically, the locking piece is unable to rotate. At this time, the locking piece moves downward and compresses the at least one second compressing spring until the locking piece reaches a lowest point, at which point the locking piece rotates into the at least one preset groove and is able to be locked at different preset positions along a groove's trajectory, thereby changing the extension length of the probe. Then, an acting force is applied to the elastic pieces by the probe to realize the extension and retraction of the probe.

Optionally, the positioning piece is a probe ball disposed on the slider. The at least one preset groove is disposed inside the housing. The probe ball is movable in the at least one preset groove to change a position of the detector.

Optionally, the elastic pieces comprise a first compressing spring and at least one second compressing spring. The first compressing spring is disposed between the slider and the detector, or the first compressing spring is embedded in the detector. The at least one second compressing spring is disposed between the slider and the housing. The positioning piece is movable to any one of the preset positions in the housing to change the length of the detector extending out of the housing, when the slider moves under the external forces and/or a force of the at least one second compressing spring. The detector is configured to detect a position of a processing surface of a workpiece by the first compressing spring to determine whether the workpiece is detected.

The probe is locked at different preset positions along a movement trajectory of the probe ball in the at least one preset groove to change the extension length of the probe. Then, the probe is pressed by the first compressing spring to realize the extension and retraction of the probe, thereby detecting the position of the processing surface of the workpiece and determining whether the processing surface is detected.

Optionally, the detector is connected to a sensing stopper. A sensing stopper stroke groove is defined on one side surface of the housing. The sensing stopper is movable in the sensing stopper stroke groove. The distance detection device further comprises a sensing assembly corresponding to the sensing stopper. The sensing stopper moves to different positions to trigger the sensing assembly. The sensing assembly is configured to detect an extended state of the detector.

The sensing stopper moving with the detector is positioned within the housing. The sensing stopper stroke groove on the housing limits a stroke of the detector. Simultaneously, the sensing assembly detects the position of the sensing stopper to determine the extended state of the detector, which facilitates position detection of the detector and facilitates triggering of the sensing assembly.

Optionally, the sensing assembly comprises a fixing piece and a printed circuit board assembly (PCBA) board disposed in the fixing piece. Signal assemblies are disposed on the PCBA board along a movement direction of the detector. Each of the signal assemblies comprises a signal transmitting end and a signal receiving end. The probe sensing blocking piece is movable between the signal transmitting end and the signal receiving end of each of the signal assemblies. When one of the signal assemblies fails to function normally, the sensing stopper is positioned between the signal transmitting end and the signal receiving end of the one of the signal assemblies.

By providing the signal assemblies, when the sensing stopper blocks the signal transmission and reception of the one of the signal assemblies, a height of the processing surface is determined according to a height of the sensing stopper corresponding to the one of the signal assemblies. The height of the sensing stopper is set to be consistent with a height of the processing head, or a certain compensated height is predefined, so that the processing head performs processing operations according to the height of the sensing stopper or the compensated height, resulting in an excellent processing effect.

Optionally, the distance detection device further comprises a pressing assembly, and the pressing assembly is capable of exerting an acting force on the pressing shaft to cause the pressing shaft to move.

The pressing assembly is configured to press the pressing shaft. The pressing assembly has the rotating shaft that uses a lever principle to generate pressing force on the pressing shaft, so that there is no need for a long pressing shaft, which would occupy a large space in a height direction of the distance detection device. Therefore, space in the height direction of the distance detection device is saved. Furthermore, a longer detection distance is realized without replacing the processing head. Alternatively, the pressing assembly is the electromagnetic ring. Energizing the electromagnetic ring makes the electromagnetic ring magnetic, and the electromagnetic ring pushes the detector downward. By adjusting the current magnitude, the detector is able to be moved to different preset positions, making control of the detector more flexible.

Optionally, the pressing assembly comprises a rotating block and a fixing block. The fixing block is connected to the rotating block through a first rotating shaft, and the rotating block is rotatable relative to the fixing block. The rotating block comprises a force receiving end and a probe contacting end in contact with the pressing shaft, and the force receiving end of the rotating block is forced to drive the rotating block to rotate, so as to drive the probe contacting end of the rotating block to apply a pressing force to the pressing shaft.

The pressing assembly is connected by the fixing block and the rotating block. The rotating block is rotatably connected to the fixing block, so that the pressing assembly is fixed in position. During a lifting and lowering process of the processing head, the processing head contacts the rotating block to make the rotating block rotate, and then make the probe contacting end of the rotating block contact the pressing shaft and generate pressing force on the pressing shaft. In this way, space in an X-axis direction is fully used to realize a pressing action of the distance detection device.

Optionally, the force receiving end of the rotating block is connected to a bearing. The probe contacting end of the rotating block defines an inclined surface, and the inclined surface of the rotating block contacts the pressing shaft. The rotating block comprises a rotating stop block. The rotating stop block is configured to limit the rotating block, so that the rotating block has a fixed pressing initial position.

The inclined surface on the probe contacting end of the rotating block increases a contact area between the rotating block and the pressing shaft during rotation, providing a more uniform and vertically downward pressing force, and improving the movement effect of the distance detection device. Simultaneously, the rotating stop block prevents the rotating block from over-resetting during a reset process after the pressing action, allowing the rotating block to quickly enter a next pressing action. Furthermore, the rotating block limits the pressing stop block, ensuring that the rotating block has the fixed pressing initial position.

The distance detection method comprises applying external forces to a distance detection device to enable a slider thereof to move to drive a detector thereof to move, which comprises applying the external forces in the same direction to the distance detection device to cause the slider to move to different preset positions, so as to change an extension length of the detector in an initial state at different preset positions, performing distance detection by moving the detector at any of the preset positions, and changing the extension length of the detector at a current preset position, and after the distance detection, returning the extension length of the detector to the extension length in the initial state at the current preset position.

The detector is pushed to move by applying a vertical downward force to the pressing shaft to move the pressing shaft in the length direction thereof and push the slider to move, then the slider moves to one of the preset positions and is relatively fixed. At this time, an extension length of the detector is a maximum extension length that needs to be extended. At the same time, the pressing shaft continues to apply a vertical downward force to move the pressing shaft to another one of the preset positions. The length of the detector extending out of the housing is changed by applying different external forces to the detector, so as to realize a distance detection of a processing surface. After the distance detection is completed, the detector returns to the maximum extension length for re-detection, so that repeated detection is realized.

Optionally, under the external forces in the same direction on the distance detection device and an elastic force, the slider is moved to different preset positions to change the extension length of the detector in the initial state.

By providing the elastic pieces, the elastic pieces are compressed when the slider moves, and a restoring force is provided for the slider to return to an initial position when the elastic pieces reset, so that the slider and the detector are enabled to return to initial positions each time, and detection accuracy is improved.

Optionally, the distance detection method further comprises resetting the detector by applying an external force on the slider along a length direction, and repeatedly moving the slider along the length direction thereof to perform distance detection.

When the detector is subjected to the force, the detector drives the elastic pieces to change the length of the detector extending out of the housing to realize the distance detection of the processing surface of the workpiece. During a detection process, the elastic pieces are compressed. After the distance detection is completed, the elastic pieces restore and push the detector to the one of the preset positions for distance detection again, so as to realize repeated distance detection.

The processing device comprises a processing head configured to process a workpiece and the distance detection device described above. The processing head is connected to the distance detection device. The distance detection device is configured to detect a distance between a processing surface of the workpiece and the distance detection device. A position of the processing head is adjusted to process the workpiece according to the distance between the processing surface of the workpiece and the distance detection device.

The distance detection device is connected to the processing head, facilitating a detection of a distance between the processing head and the processing surface. An operating mode of the processing head is then adjusted to realize a good processing effect. Furthermore, because a detection height of the distance detection device is adjustable, the distance detection device is allowed to connect with different processing heads to detect the distance thereof to the processing surface of the workpiece.

Optionally, the processing device further comprises moving devices, and the moving devices are configured to drive the processing head to move in three dimensions. The moving devices comprise a Z-axis moving device. A movable block is disposed on the Z-axis moving device. The movable block moves with the processing head. A pressing assembly is disposed on one side of the processing head. The pressing assembly only moves with the processing head in an X-axis direction and a Y-axis direction. When the processing head moves in a Z-axis direction, the pressing assembly applies a force to the pressing shaft. A sensing assembly is disposed in the processing head. The sensing assembly is configured to detect a state of the detector.

The moving devices are movable in three dimensions to realize precise positioning. The movement of the Z-axis moving device drives the movable block to move. The movable block provides the pressing force to the pressing assembly enabling the processing head to self-reset during the Z-axis movement, and then quickly proceed to a distance detection of a next workpiece, thereby improving work efficiency.

A working status of the processing operation of the processing device is determined by detecting the extended state of the probe shaft (the probe and the detector mentioned above). When the probe shaft is extended, the distance to the workpiece is detected, and the processing head is then focused. When the probe shaft is retracted, it is then controlled to be extended. Furthermore, when the processing head is operating, the probe shaft is retracted, and the distance detection device no longer needs to be reset at a reset position when extending and retracting at different positions. The distance detection device is able to reset in the X-axis and Y-axis directions and then quickly measure the distance to the processing surface of the workpiece, thereby reducing movement time and improving work efficiency. The distance detection device is magnetically connected to the processing head, which facilitates quick mounting and removal. The distance detection device is able to flexibly adapt to various processing heads and realize extension and retraction of the probe in the same direction. In addition, the present disclosure utilizes the lever principle to solve a problem of insufficient processing head movement space leading to a short extension distance of the distance detection device. Moreover, the distance detection device causes less damage to the processing surface of the workpiece, has lower cost and maintenance costs, and a simple and compact overall structure. Compared to a sensor detection solutions, the distance detection device is able to continuously detect the processing surface of the workpiece and generate flat surface information or curved surface information of the workpiece. Compared to an electromagnetic detection solution the distance detection device is less expensive and has a compact and reliable structure.

### BRIEF DESCRIPTION OF DRAWINGS

To more clearly illustrate technical solutions in the embodiments of the present disclosure or the prior art, the present disclosure is further described below in conjunction with the accompanying drawings and embodiments.

FIG. 1 is a perspective schematic diagram of a processing device according to a first embodiment of the present disclosure.

FIG. 2 is a schematic diagram of a distance detection device connected to a moving device of a laser according to the first embodiment of the present disclosure.

FIG. 3 is a perspective schematic diagram of the distance detection device according to the first embodiment of the present disclosure.

FIG. 4 is an exploded schematic diagram of the distance detection device according to the first embodiment of the present disclosure.

FIG. 5 is a partial exploded schematic diagram of the distance detection device according to the first embodiment of the present disclosure.

FIG. 6 is a cross-sectional schematic diagram of a probe hook according to the first embodiment of the present disclosure, where a movable end of the probe hook is in an initial position.

FIG. 7 is a cross-sectional schematic diagram of a probe hook according to the first embodiment of the present disclosure, where the movable end of the probe hook is at an ascending section.

FIG. 8 is a cross-sectional schematic diagram of a probe hook according to the first embodiment of the present disclosure, where the movable end of the probe hook is at a first high point.

FIG. 9 is a cross-sectional schematic diagram of a probe hook according to the first embodiment of the present disclosure, where the movable end of the probe hook is at a positioning point.

FIG. 10 is a cross-sectional schematic diagram of a probe hook according to the first embodiment of the present disclosure, where the movable end of the probe hook is at a second high point.

FIG. 11 is a cross-sectional schematic diagram of a probe hook according to the first embodiment of the present disclosure, where the movable end of the probe hook is at a descending section.

FIG. 12 is a cross-sectional schematic diagram of a probe hook according to the first embodiment of the present disclosure, where the movable end of the probe hook is in a hook sliding groove.

FIG. 13 is an exploded schematic diagram of a pressing assembly according to the first embodiment of the present disclosure.

FIG. 14 is a perspective schematic diagram of the pressing assembly according to the first embodiment of the present disclosure, where the pressing assembly is not pressed.

FIG. 15 is a perspective schematic diagram of the pressing assembly according to the first embodiment of the present disclosure, where the pressing assembly is pressed.

FIG. 16 is a perspective schematic diagram of a sensing assembly according to the first embodiment of the present disclosure.

FIG. 17 is an exploded schematic diagram of the sensing assembly according to the first embodiment of the present disclosure.

FIG. 18 is a schematic diagram of the sensing assembly according to the first embodiment of the present disclosure, where the sensing assembly is placed in a first signal assembly.

FIG. 19 is a schematic diagram of the sensing assembly according to the first embodiment of the present disclosure, where the sensing assembly is placed in a second signal assembly.

FIG. 20 is a schematic diagram of the processing device according to the first embodiment of the present disclosure, where the processing device is in a pressed state.

FIG. 21 is a schematic diagram of the pressing assembly connected to the moving device of the laser according to the first embodiment of the present disclosure.

FIG. 22 is a side schematic diagram of the distance detection device and the laser according to the first embodiment of the present disclosure.

FIG. 23 is a perspective schematic diagram of the distance detection device and the laser according to the first embodiment of the present disclosure.

FIG. 24 is a schematic diagram of the distance detection device, the moving device and the laser according to the first embodiment of the present disclosure.

FIG. 25 is a schematic diagram of the processing device according to the first embodiment of the present disclosure, where the processing device is not pressed.

FIG. 26 is a schematic diagram of the processing device according to the first embodiment of the present disclosure, where the processing device is not pressed and a probe shaft of a probe is extended.

FIG. 27 is a perspective schematic diagram of the moving device connected to the laser according to the first embodiment of the present disclosure.

FIG. 28 is a perspective schematic diagram of the processing device connected to the pressing assembly according to the first embodiment of the present disclosure.

FIG. 29 is an enlarged schematic diagram of portion A shown in FIG. 28.

FIG. 30 is a schematic diagram of the distance detection device connected to the moving device of the laser according to a second embodiment of the present disclosure.

FIG. 31 is an exploded schematic diagram of the distance detection device according to the second embodiment of the present disclosure.

FIG. 32 is a cross-sectional schematic diagram of the distance detection device according to the second embodiment of the present disclosure.

FIG. 33 is a schematic diagram of the distance detection device according to the second embodiment of the present disclosure.

FIG. 34 is a schematic diagram of a locking piece of the distance detection device according to the second embodiment of the present disclosure.

FIG. 35 is a schematic diagram of the distance detection device connected to the moving device of the laser according to a third embodiment of the present disclosure.

FIG. 36 is an exploded schematic diagram of the distance detection device according to the third embodiment of the present disclosure.

FIG. 37 is a cross-sectional schematic diagram of the distance detection device according to the third embodiment of the present disclosure.

FIG. 38 is a cross-sectional schematic diagram of a detection ball according to the third embodiment of the present disclosure, where the detection ball is placed in the high point.

FIG. 39 is a cross-sectional schematic diagram of the detection ball according to the third embodiment of the present disclosure, where the detection ball is placed in an intermediate point.

FIG. 40 is a cross-sectional schematic diagram of the detection ball according to the third embodiment of the present disclosure, where the detection ball is placed in the low e point.

FIG. 41 is a schematic diagram of a ball sliding groove according to the third embodiment of the present disclosure, where the ball sliding groove is in an unfolded state.

FIG. 42 is a schematic diagram of a movement trajectory of the detection ball in the ball sliding groove according to the third embodiment of the present disclosure, where the ball sliding groove is in the unfolded state.

### DETAILED DESCRIPTION

### Embodiment 1

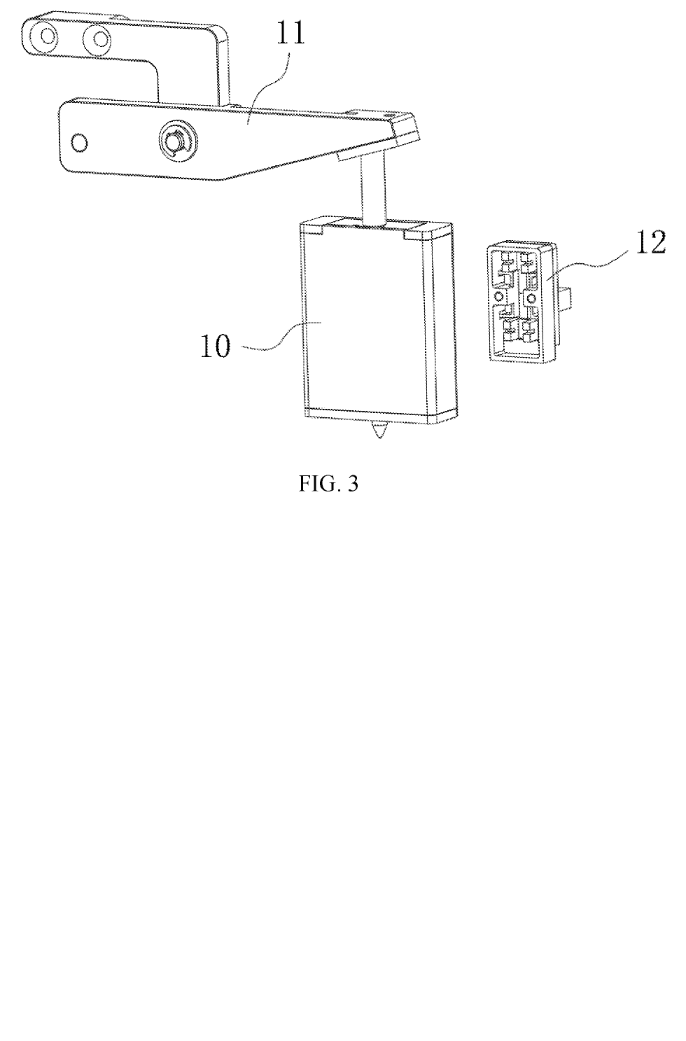

The embodiment provides a distance detection device and a distance detection method. As shown in FIG. 3, the distance detection device comprises a probe assembly 10 and a pressing assembly 11 configured to apply a pressing force to the probe assembly. The pressing assembly 11 applies external forces to the probe assembly 10 to adjust an extension length of the probe assembly, thereby realizing distance detection. A sensing assembly 12 is disposed on one side of the probe assembly 10. The sensing assembly 12 is configured to sense and detect an extended state of the probe assembly to improve accuracy of distance detection. The distance detection device is allowed to be in conjunction with a laser engraving machine to detect a distance between a processing surface of a workpiece and a laser.

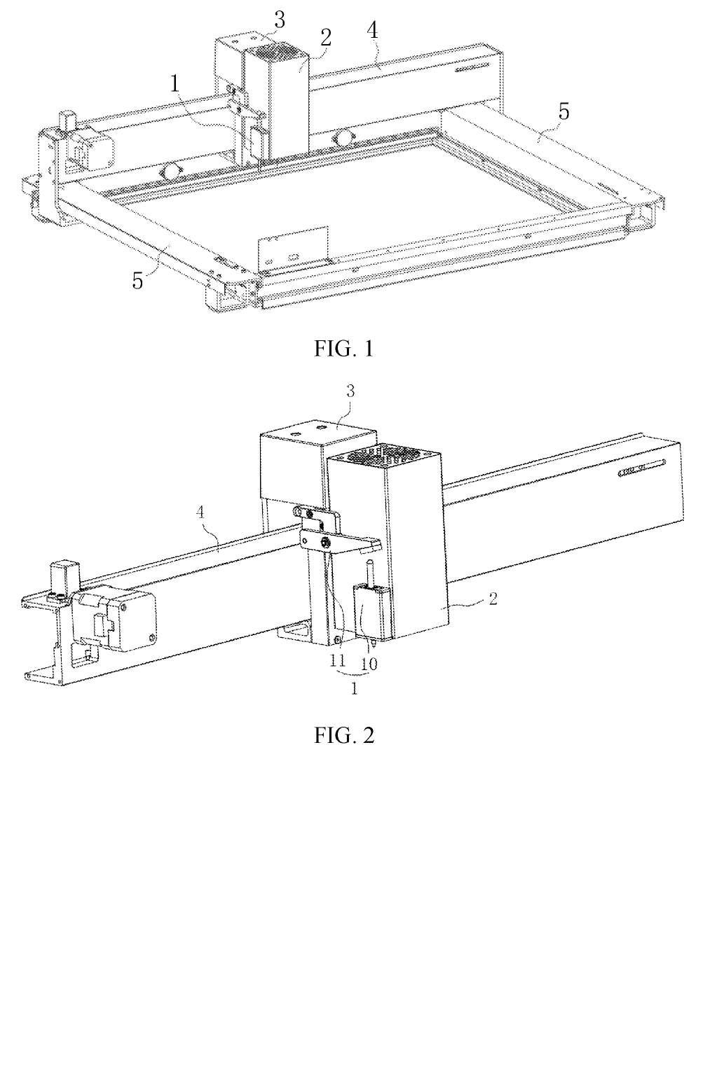

As shown in FIGS. 1-2, the laser 2 is mounted on a bracket. The bracket comprises two Y-axis moving devices 5 for the laser 2, and an X-axis moving device 4 for the laser. The two Y-axis moving devices 5 are opposite to each other. The X-axis moving device 4 connects corresponding two ends of the two Y-axis moving devices 5. The X-axis moving device 4 is movable back and forth along a Y-axis direction on the two Y-axis moving devices. A Z-axis moving device 3 is disposed on the X-axis moving device. The Z-axis moving device 3 is movable back and forth along an X-axis direction on the X-axis moving device. The laser 2 is mounted on the Z-axis moving device 3 and is movable back and forth along a Z-axis direction on the Z-axis moving device. The X-axis moving device 4 and the two Y-axis moving devices 5 jointly define a processing area. The laser performs processing operations within the processing area, and the processing operations comprise laser engraving, laser cutting, laser marking, etc. The embodiment takes laser engraving as an example for further illustration.

The X-axis moving device 4 is movable on the two Y-axis moving devices to drive the laser and the Z-axis moving device to move in the Y-axis direction within the processing area. The Z-axis moving device is movable on the X-axis moving device to drive the laser and the Z-axis moving device to move in the X-axis direction of the processing area, thereby realizing precise positioning of the laser at any position in the processing area before laser engraving. A movement of the laser 2 on the Z-axis moving device is configured to adjust an optimal engraving distance between the laser and a point or a surface to be engraved of the workpiece, ensuring the laser and the point or the surface to be engraved (i.e., a processing surface) of the workpiece are at the optimal engraving distance. Furthermore, a height of the point or the surface to be engraved on the workpiece is detected by the distance detection device, and then the Z-axis moving device adjusts the position of the laser 2 in the Z-axis direction to obtain an optimal engraving position, ensuring that an engraving effect at each position is optimal for the processing surface of the workpiece that is uneven or has varying height.

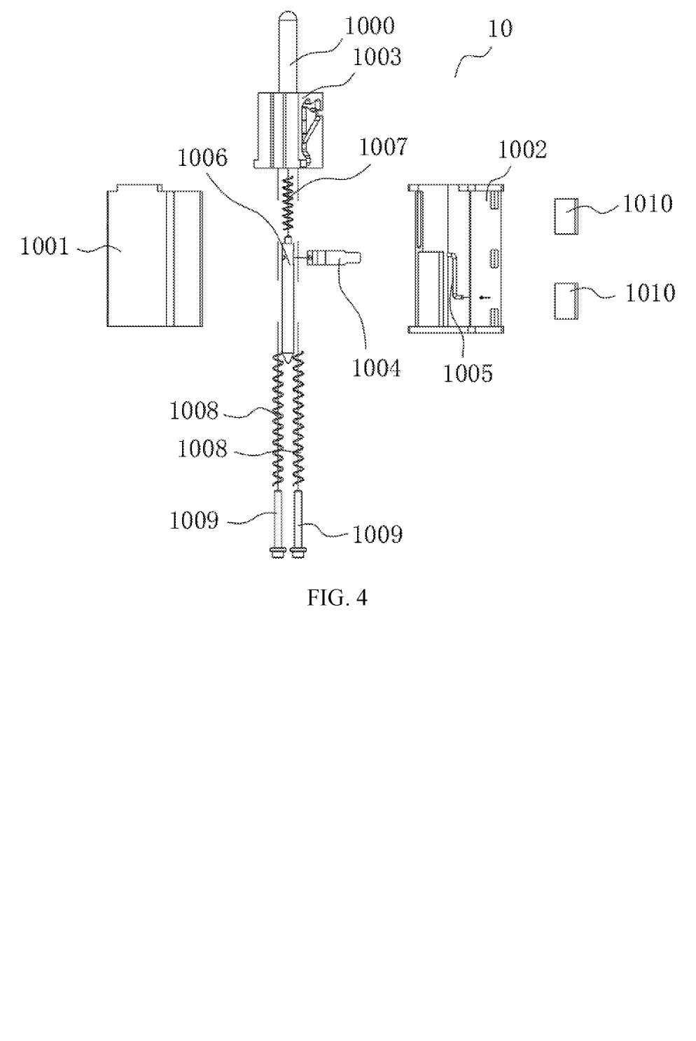

Specifically, as shown in FIGS. 3-4, the probe assembly 10 comprises a lower housing 1002 and an upper housing 1001 covering on the lower housing 1002. The upper housing 1001 and the lower housing 1002 jointly form a housing. A sliding block 1003 is disposed between the upper housing 1001 and the lower housing 1002. A pressing shaft 1000 extending from an upper end of the housing is disposed on an upper end of the sliding block. The pressing shaft 1000 and the sliding block 1003 are integrally formed. When a pressing force is applied to the pressing shaft, the pressing shaft 1000 moves, causing the sliding block 1003 to move with the pressing shaft 1000. The lower housing 10202 defines a sliding groove 10020. The sliding block is slidable up and down when being placed in the sliding groove 10020. The probe assembly 10 further comprises a probe shaft1006 disposed between the upper housing and the lower housing. The probe shaft partially extends out of a lower end of the housing and is partially disposed inside the housing. A first compressing spring 1007 is disposed between the sliding block 1003 and an upper end of the probe shaft 1006. A central hole is defined on a lower end of the sliding block. The probe shaft 1006 is coaxially disposed with the central hole. The probe shaft 1006 passes through the central hole and moves vertically (in the Z-axis direction) in the central hole. The first compressing spring 1007 is coaxially disposed with the probe shaft 1006. The upper end of the first compressing spring 1007 abuts against the sliding block 1003, and a lower end of the first compressing spring 1007 abuts against the probe shaft 1006.

The distance detection device further comprises a sensing stopper 1004 fixedly connected to the probe shaft 1006 as a whole. The sensing stopper 1004 limits the probe shaft in the sliding block. The first compressing spring is disposed inside the sliding block, and the sliding block limits the sensing stopper 1004 from moving vertically (in the Z-axis direction). Furthermore, the probe shaft is movable up and down in the central hole of the sliding block to compress the first compressing spring. When the first compressing spring that is compressed is released to reset, the first compressing spring pushes the probe shaft back to reset.

Further, as shown in FIGS. 3-4, the probe assembly 10 further comprises two second compressing springs 1008 disposed below the sliding block 1003. The two second compressing springs are respectively disposed on two sides of the probe shaft. An upper end of each of the second compressing springs 1008 contacts the lower end of the sliding block, and a lower end of each of the second compressing springs 1008 contacts the lower housing. The sliding block is slidable within the sliding groove 10020 and is able to compress the second compressing springs. After the second compressing springs are realized, the second compressing springs reset, causing the sliding block to reset. To prevent the second compressing springs from deforming under pressure and failing to reset, the second compressing springs are respectively sleeved on two compressing spring stoppers 1009. The sliding block 1003 defines two vertical through holes corresponding to the two compressing spring stoppers 1009. When the sliding block 1003 slides downward, the two compressing spring stoppers are respectively located in the two vertical through holes. A probe hook 1005 is disposed inside the lower housing. A first end of the probe hook 1035 is fixedly disposed inside the lower housing, and a second end of the probe hook 1035 moves relative to the sliding block 1003 to enable that the probe shaft has different extension lengths. The lower housing 1002 defines a sensing stopper stroke groove 1011 on one side thereof. The sensing stopper is movable along the sensing stopper stroke groove 1011, and the sensing stopper stroke groove 1011 provides space for the sensing stopper 1004 to extend out. The sensing stopper 1004 passes through the sensing stopper stroke groove 1011 and is corresponding to sensing assemblies, so that the sensing assemblies are allowed to determine the extension length of the probe shaft 1006. To facilitate connection between the probe assembly 10 and the laser 2, two magnets 1010 are disposed on one side of the lower housing 1002. The probe assembly 10 is mounted on the laser 2 by an attraction between the two magnets 1010 and the laser 2. Alternatively, screws or other mounting methods can be adopted to connect the probe assembly to the laser, which are not limited thereto.

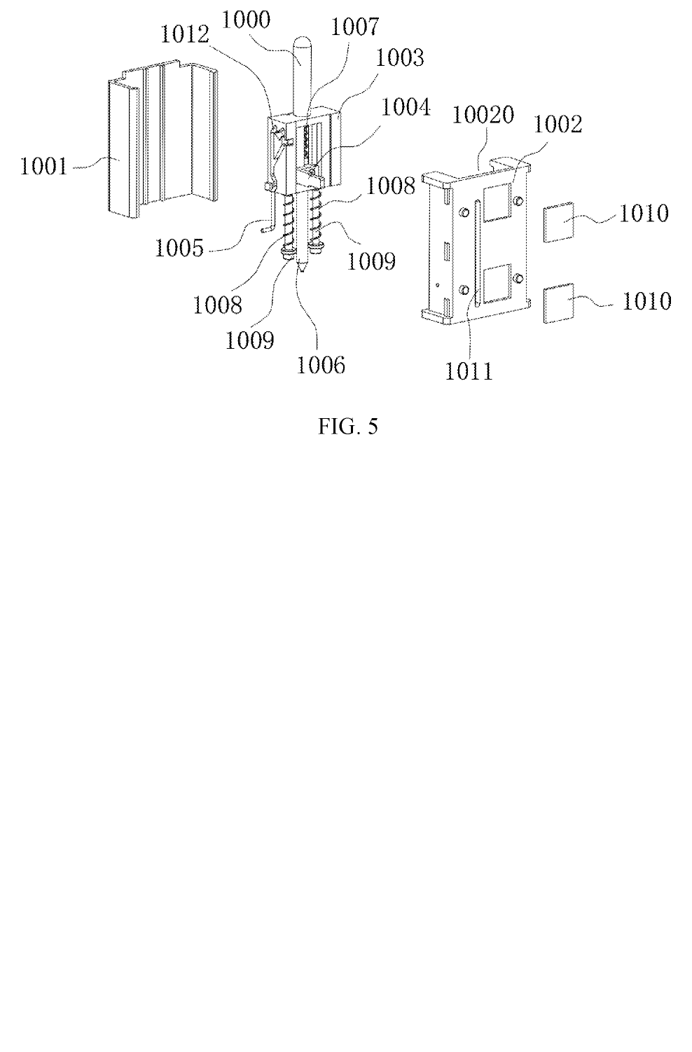

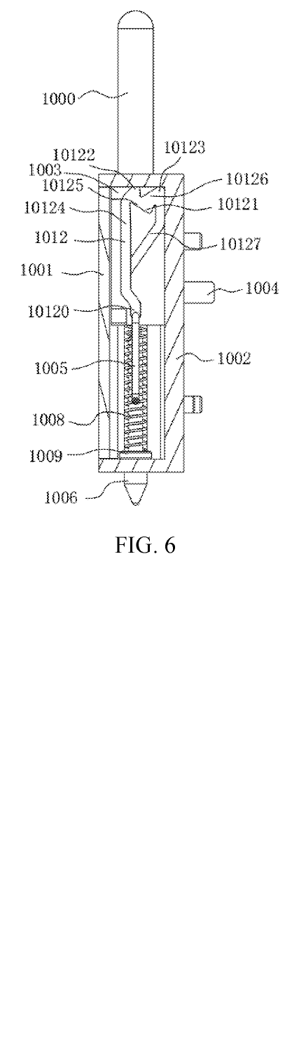

Furthermore, as shown in FIG. 5-6, a hook sliding groove 1012 is defined on one side of the sliding block 1003. The first end of the probe hook 1005 is fixed in the lower housing 1002, and the second end of the probe hook 1005 is slidable in the hook sliding groove 1012. The second end of the probe hook 1005 is able to slide to different positions of the hook sliding groove 1012, thereby causing the probe shaft to extend to different extension lengths and realizing the distance detection of the workpiece by the probe assembly. The second end of the probe hook 1005 is positioned in different positions of the hook sliding groove 1012 to further fix the position of the sliding block 1003 relative to the lower housing 1002, making it easy to adjust the position of the probe shaft 1006. The hook sliding groove 1012 is heart-shaped. The hook sliding groove 1012 comprises an ascending section 10124 and a lower inclined section 10125. A lowest point of the ascending section 10124 is defined as an initial point 10120, and a highest point of the ascending section 10124 is defined as a first high point 10122. The ascending section 10124 is connected to the lower inclined section 10125. The first high point 10122 is located vertically above the lower inclined section 10125. When the probe hook 1005 is at the first high point 10122, the probe hook 1005 falls vertically into the lower inclined section 10125. An end portion of the lower inclined section 10125 is defined as a positioning point 10121. The hook sliding groove 1012 further comprises an upper inclined section 10126 and a descending section 10127. The lower inclined section 10125 is connected to the upper inclined section 10126. An end portion of the upper inclined section forms a second high point 10123. The upper inclined section 10126 is connected to the descending section 10127. The second high point 10123 is located vertically above the descending section 10127. When the probe hook is at the second high point 10123, the probe hook falls vertically into the descending section 10127. An end portion of the descending section 10127 is defined as an initial point. In the embodiment, only two high points and one positioning points are provided. Alternatively, as needed, the lower inclined section 10125 is connected below the upper inclined section 10126 to form another positioning point 10121, thereby realizing limiting of the probe hook at different positions. However, it must be ensured that the probe hook enters the lower inclined section after falling vertically from any one of the high points. It should be noted that the first high point 10122 and the second high point 10123 may be set to different heights, and when a plurality of positioning points are provided, the heights of the positioning points may be set to be not exactly the same.

Furthermore, as shown in FIG. 3-4, during the assembly of the probe assembly 10, the first end of the probe hook 1005 is first mounted in the hole of the lower housing 1002. Then, the probe shaft 1006 and the first compressing spring 1007 are placed in the center hole of the sliding block 1003, and the probe shaft 1006 and the first compressing spring 1007 are limited in the sliding block 1003 by the sensing stopper 1004. It should be noted that the probe shaft is movable relative to the sliding block 1003 at this time, and the probe shaft 1006 is able to compress the first compressing spring 1007, or the probe shaft is pushed relative to the sliding block 1003 by the thrust of the first compressing spring. When the lower end of the probe shaft is subjected to the pressing force, the probe shaft moves upward, reducing the extension length and compressing the first compressing spring 1007. When the pressing force at the lower end of the probe shaft is released, the first compressing spring 1007 resets and pushes the probe shaft, so that the extension length of the probe shaft returns to a preset value. Alternatively, the first compressing spring 1007 is omitted, so that the lower end of the probe shaft moves downward under gravity when no force is applied and the extension length of the probe shaft increases to the preset value. Relatively speaking, it is better to provide the first compressing spring 1007 to apply a preload force to the probe shaft, which avoids measurement errors caused by the probe shaft wobbling and improves a distance detection effect. Then, the second compressing springs 1008 are respectively sleeved on outer sides of the compressing spring stoppers 1009 and are placed in the two vertical through holes on one side of the sliding block 1003. The sliding block 1003 is then mounted in the sliding groove of the lower housing 1002 having the probe hook. The second end of the probe hook is placed in the hook sliding groove 1012, and the upper housing 1001 is fastened. Then, the probe magnet 1010 is fixed on the lower shell. In this way, the assembly of the probe assembly is completed.

As shown in FIGS. 3-4, in the probe assembly 10, the first compressing spring 1007 is compressed and in a compressed state, providing a downward force to the probe shaft. The second compressing springs 1008 are also compressed and in the compressed state. At this time, the sliding block 1003 is at a topmost position, the probe shaft extends to have a shortest extension length, and the pressing shaft 1000 extends to a longest extension length. A movable end (i.e., the second end) of the probe hook is at the initial point 10120. Alternatively, the first compressing spring 1007 and the second compressing springs 1008 are in a non-compressed state. When the first compressing spring 1007 and the second compressing spring 1008 are compressed, the sliding block 1003 and the probe shaft 1006 have preload force in their initial positions. Under compression, the second compressing springs 1008 pushed the sliding block 1003 away, so that the sliding block 1003 moves to the topmost position thereof. When the first compressing spring 1007 is compressed, the first compressing spring 1007 pushes the probe shaft 1006 away, so that the probe shaft 1003 moves to the initial position thereof. If the first compressing spring 1007 and the second compressing springs 1008 are in the non-compressed state when the probe shaft 1006 is in the initial position thereof and the sliding block 1003 is in the initial position thereof, it is not ensured that the probe shaft 1006 and the sliding block 1003 are accurately positioned in the predetermined positions during the movement of the probe assembly 10. Therefore, the first compressing spring and the second compressing springs need to have reasonable lengths, and the probe shafts thereof should not change over long-term use. Thus, in the embodiment, in an initial state, the first compressing spring 1007 and the second compressing springs 1008 are subjected to a certain pressing force to ensure that the probe shaft 1006 and the sliding block 1003 accurately reach the predetermined positions during movement. The sensing stopper 1004 passes through the sensing stopper stroke groove 1011 and is partially positioned above the sensing stopper stroke groove.

In the initial position, the pressing shaft 1000 is subjected to a downward pressing force, which drives the sliding block 1003 downward and the probe shaft 1006 downward. During a downward movement of the probe shaft, the second compressing springs 1008 are compressed. The sliding block 1003 moves downward under the external forces, and the probe shaft extends downward to continuously compress the second compressing springs. After the pressing force is released, the probe shaft of the second compressing springs resets the sliding block 1003. At this moment, the probe shaft 1006 is extended, a Z-axis motor drives the laser 2 and the distance detection device 10 to descend. When the probe shaft contacts the processing surface of the workpiece during the downward movement, the processing surface of the workpiece exerts a pushing force on the probe shaft, causing the probe shaft to move upward. The sensing stopper 1004 moves upward synchronously. When the sensing stopper leaves from one of the signal assemblies, it indicates that the processing surface of the workpiece has been detected.

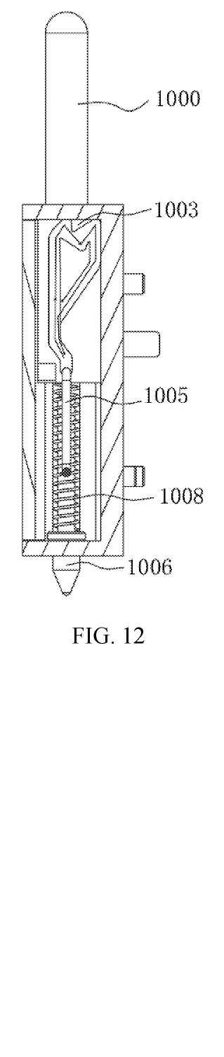

Upon detecting a contact signal, the distance detection device and the laser rise, and the restoring force of the first compressing spring 1007 resets the probe shaft. The first compressing spring 1007 and the second compressing springs 1008 are constantly compressed, and a degree of compression is even greater when the pressing force is applied. After the pressing force is released, the restoring force drives the probe shaft to move. A working principle of the probe assembly 10 is illustrated below. As shown in FIG. 12 , the sliding block 1003 moves vertically up and down, and the movable end (the second end) of the probe hook 1005 moves cyclically along the hook sliding groove 1012, that is, cyclically passes different points within the hook sliding groove, thereby realizing the extension and retraction of the probe shaft 1006.FIG. 6 shows the probe hook of the probe assembly at the initial point. At this time, the movable end of the probe hook is at the initial point 10120, the first compressing spring 1007 and the second compressing springs are in the compressed state, the extension length of the probe shaft 1006 is the shortest, and the extension length of the pressing shaft 1000 is longer.

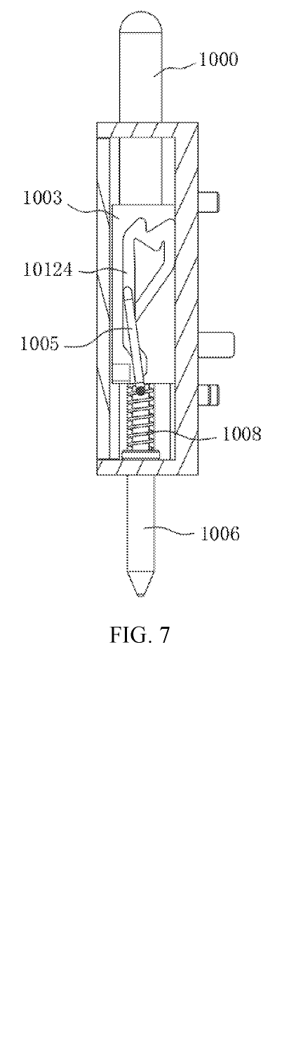

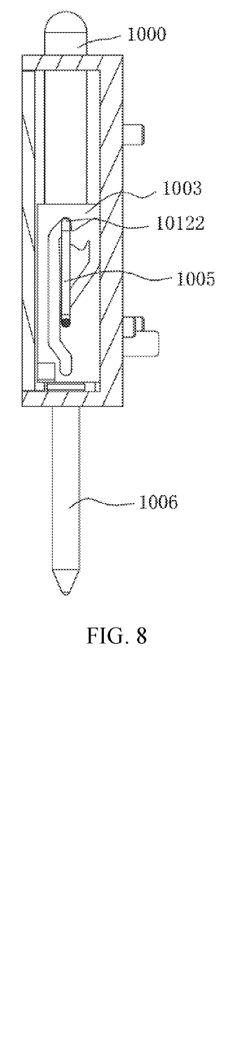

As shown in FIG. 7, the probe hook of the probe assembly is in the ascending section relative to the sliding block 1003. When the pressing force is applied to the pressing shaft 1000 to make the pressing shaft 1000 linearly move downward, the pressing shaft 1000 drives the sliding block 1003 to move downward, so that the movable end of the probe hook gradually rises in the rising section 10124. At this time, the probe shaft 1006 extends to a longer extension length, and the compression degree of the second compressing springs 1008 gradually increases. As shown in FIG. 8, the probe hook of the probe assembly is at the first high point, and pressing force is continuously applied to the pressing shaft. When the pressing shaft is subjected to the pressing force and the movable end of the probe hook is in the first high point 10122, the probe shaft extends to have a maximum extension length, the pressing shaft extends to have a minimum extension length, and the second compressing springs are in a maximum compression degree.

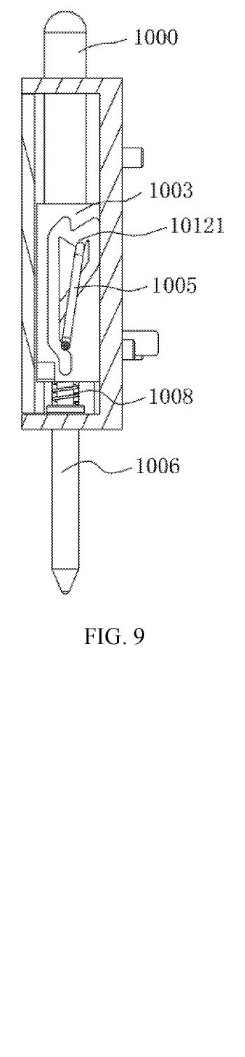

At this time, the pressing force on the pressing shaft 1000 is released FIG. 9. shows the probe hook of the probe assembly at the positioning point. When the pressing force on the pressing shaft 1000 disappears, the restoring force generated by the second compressing springs 1008 exerts a vertical upward thrust on the sliding block 1003, causing the sliding block 1003 to linearly move upward. At this moment, the movable end of the probe hook moves downward relative to the sliding block 1003. Since the first high point is directly above the lower inclined section in the vertical direction, the probe hook moves downward relative to the sliding block 1003 to the lower inclined section 10125. Since the lower inclined section is inclined, the movable end of the probe hook 1005 moves relative to the sliding block 1003 along the lower inclined section to the positioning point 10121. Moreover, the probe shaft 1006 is in the extended state, and the probe shaft elastically moves in the central hole of the sliding block 1003 under the action of the restoring force of the first compressing spring 1007, which facilitates the detection of the processing surface of the workpiece. The probe assembly 10 shown in FIG. 9 is able to detect the distance between the processing surface of the workpiece and the laser.

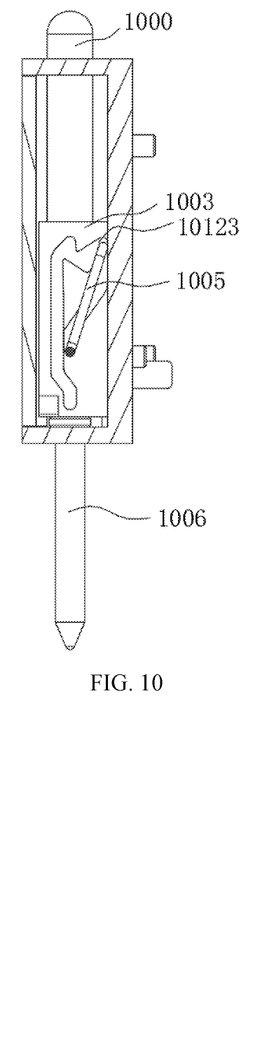

Furthermore, when the probe hook of the probe assembly shown in FIG. 9 is in the positioning point, the pressing force is applied to the pressing shaft 1000, causing the pressing shaft 1000 to linearly move downward. The sliding block 1003 also moves linearly downward as shown in FIG. 10. At this moment, the probe hook of the probe assembly is at the second high point. Specifically, the movable end of the probe hook 1005 moves relative to the sliding block 1003 along the upper inclined section 10126 and continues to move to the second high point 10123.

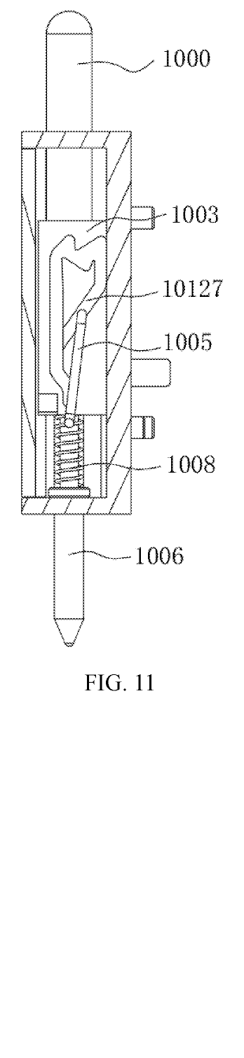

When the pressing force of the pressing shaft 1000 is released again, as shown in FIG. 11, the probe hook of the probe assembly is in the descending section relative to the sliding block 1003. At this time, the second compressing springs 1008 reset under pressure, generating the vertically upward thrust on the sliding block 1003, causing the sliding block 1003 to linearly move upward, and causing the movable end of the probe hook to linearly move downward relative to the sliding block 1003. Since the second high point is directly above the descending section in the vertical direction, the probe hook moves downward relative to the sliding block 1003 into the descending section. Furthermore, since the endpoint of the descending section is the initial point, the probe hook is then returned to the initial position. At this time, the probe shaft 1006 is in the retracted state (i.e., the extension length is the minimum), and the extension length of the pressing shaft is the maximum, thus forming the state shown in FIG. 6 and forming a complete cycle movement. The pressing shaft 1000 is able to be pressed again to make the movable end of the probe hook 1005 move back and forth relative to the sliding block 1003 in the hook sliding groove1012, and a movement trajectory of the probe hook relative to the sliding block 1003 is shown in FIG. 12.

Regarding the first compressing spring 1007, when the movable end of the probe hook 1005 is at the positioning point 10121 in the hook sliding groove 1012, the extension length of the probe shaft 1006 is recorded as the maximum extension length. When the lower end of the probe shaft is subjected to the vertical upward force, the probe shaft pushes the probe shaft to move upward, the extension length of the probe shaft gradually decreases, and the first compressing spring is compressed at the same time. After the external force at the lower end of the probe shaft is released, the first compressing spring resets and pushes the probe shaft back to the maximum extension length. Therefore, the first compressing spring allows the probe shaft to return to the predetermined length in the current state when it is not subjected to the pushing force, so that the maximum extension length of the probe shaft in the current state is the same as that in a subsequent detection process, and detection accuracy is higher.

Furthermore, to realize detection of distances of surfaces of different workpieces and the laser, the probe assembly 10 is configured with varying extension lengths as needed. However, when the extension length of the probe assembly 10 is configured to be large, a moving space for the laser to move along the Z-axis is limited, resulting in insufficient extension of the probe shaft 1006. Therefore, a problem of insufficient extension of the probe shaft caused by a limited Z-axis moving space of the laser is solved by providing a pressing assembly 11 to apply the external force to the probe assembly. The pressing assembly uses a lever principle to address the problem of insufficient extension of the probe shaft caused by the limited Z-axis moving space of the laser.

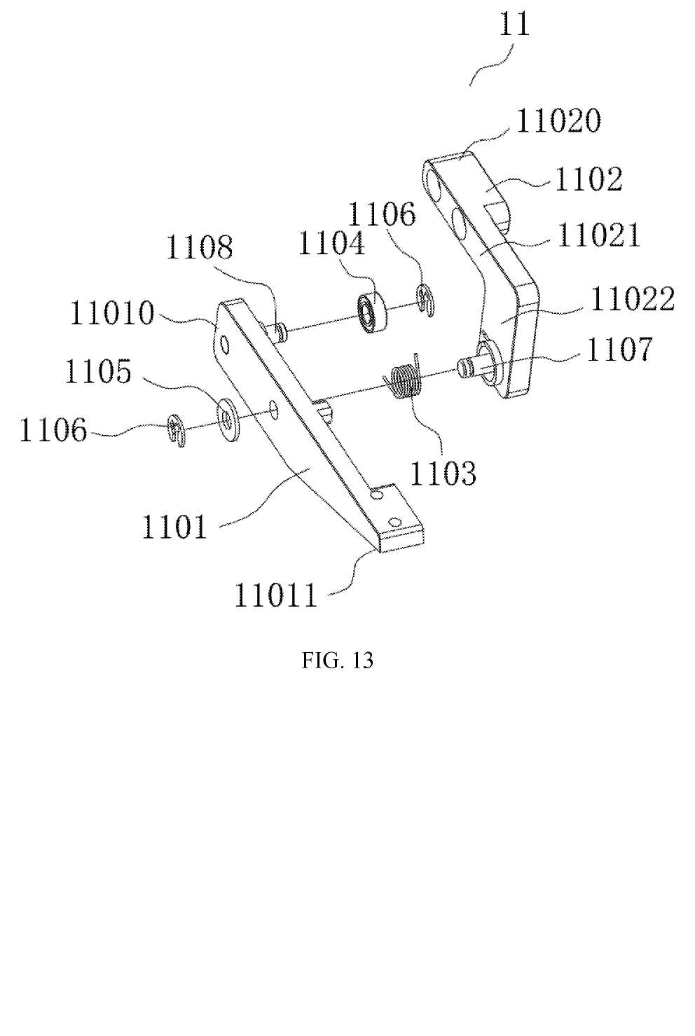

Furthermore, as shown in FIG. 13, the pressing assembly 11 comprises a fixing block 1102 and a rotating block 1101 connected to the fixing block. A first rotating shaft 1107 is disposed on a first end of the fixing block, and a middle portion of a first end of the rotating block is connected to the first rotating shaft. A torsion spring 1103 is disposed on the first rotating shaft 1107. A second end of the rotating block is fixed to the first rotating shaft through a washer 1105 and a jump ring 1106, so that the fixing block and the rotating block are rotatable relative to each other along the first rotating shaft 1107. A second end of the fixing block is fixedly mounted on a Z-axis moving device 3 for the laser, so the fixing block is fixed relative to a Z-axis fixing piece. The first end of the rotating block 1101 contacts a movable block 3001, and the second end of the rotating block 1101 rotates via the first rotating shaft 1107, causing a probe contacting end 11011 to rotate, thereby pressing the pressing shaft.

Further, as shown in FIG. 13, the fixing block 1102 is generally L-shaped. The fixing block 1102 comprises a horizontal arm 11021 and a vertical arm 11022. The horizontal arm and the vertical arm are integrally connected, and the first rotating shaft 1107 is disposed on an end portion of the vertical arm 11022. The end portion of the horizontal arm 11021 forms a fixing end 11020. The fixing end 11020 of the horizontal arm 11021 is configured to fix the horizontal arm to the Z-axis moving device 3 for the laser, thereby fixing the fixing block. The fixing block is L-shaped to further reduce the space required for the movement of the pressing assembly. Further, the horizontal arm plays a certain role in stopping the rotating block, thereby limiting a rotation stroke of the rotating block. A second rotating shaft 1108 is disposed on a force receiving end 11010 of the rotating block. Another bearing 1104 and another jump ring 1106 are sleeved on the second rotating shaft 1108.

A connection position of the first rotating shaft and the rotating block is closer to the force receiving end of the rotating block, making a distance from the first rotating shaft to the force receiving end less than a distance from the first rotating shaft to the probe contacting end 11011. In the case, other moving components integrated with the laser are moveable in the Z-axis direction and contact the bearing on the second rotating shaft, thereby driving the force receiving end 11010 to move. A movement of the force receiving end 11010 drives the probe contacting end 11011 to move in an opposite direction through the first rotating shaft 1107, so that the probe contacting end 11011 contacts the probe assembly to press the probe assembly. Moreover, to realize a better pressing effect, one side of the probe contacting end 11011 facing the probe assembly is an inclined surface, which optimizes an angle of force application between the probe contacting end and the pressing shaft during rotation, thus realizing a better pressing effect.

Furthermore, as shown in FIG. 13, when assembling the pressing assembly 11, the second rotating shaft 1108 is embedded in the rotating block 1101, and then the bearing 1104 is sleeved on the second rotating shaft and secured with a corresponding jump ring 1106. Next, the first rotating shaft 1107 is embedded in the rotating block 1102, and then the torsion spring 1103 is sleeved on the first rotating shaft. The rotating block is then fixed to the fixing block with a washer 1105 and a corresponding jump ring 1106 to complete the assembly. Finally, the pressing assembly 11 is fixed to the Z-axis moving device 3 for the laser.

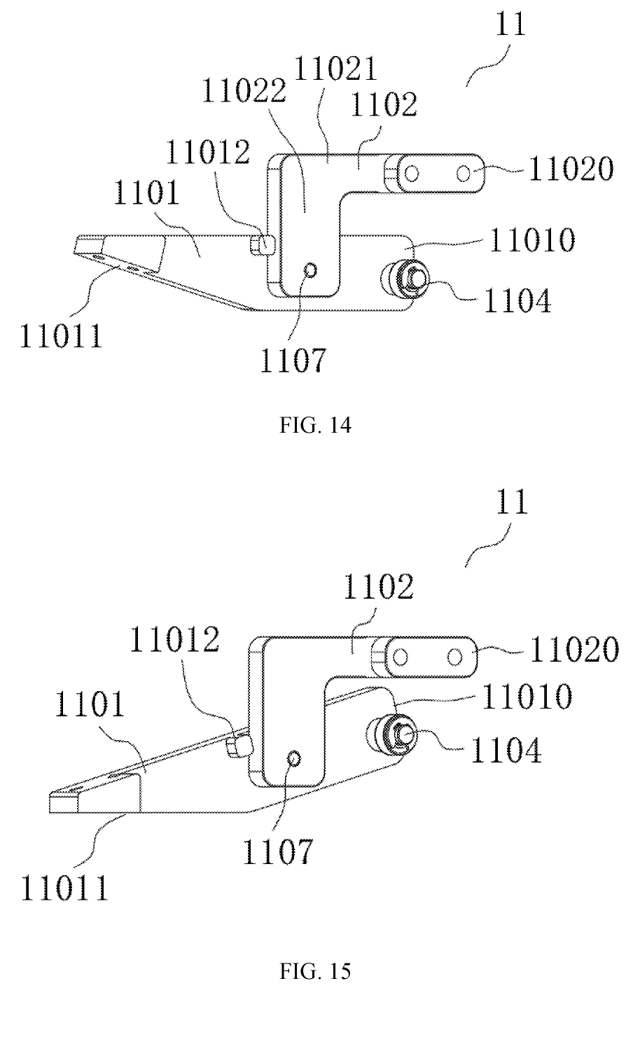

As shown in FIGS. 14-15, when the pressing assembly 11 is in the working state and when the bearing 1104 is subjected to an upward vertical force by a fixing piece that moves with the laser, the rotating block 1101 rotates around the first rotating shaft 1107, causing the first torsion spring to deform. At this time, the probe contacting end 11011 of the rotating block moves downward and presses the probe assembly, applying a downward pressing force to the probe assembly 10 to perform the aforementioned action, thereby realizing the distance detection of the processing surface of the workpiece. When the external force applied to the bearing 1104 is released, the first torsion spring resets, causing the rotating block 1101 to reset. A rotating stop block 11012 is disposed on the rotating block to prevent inertia generated when the first torsion spring resets from causing the rotating block to continue rotating, thereby enabling the same initial position of the rotating block 1101 for the next pressing action. Of course, the rotating stop block 11012 is not necessary; a reset and pressing function is still realized without the rotating stop block 11012.

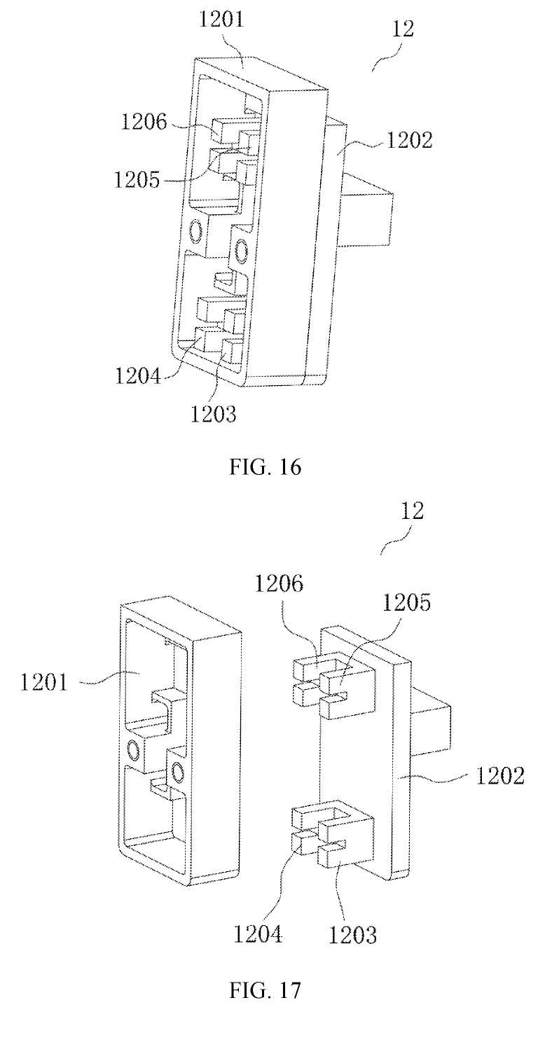

Further, as shown in FIGS. 16-17, the distance detection device further comprises a sensing assembly 12. The sensing assembly contacts the probe assembly and detects the extended state and the retracted state of the probe assembly. The sensing assembly 12 comprises a fixing piece 1201 and a printed circuit board assembly (PCBA) board 1202. A first signal transmitting end 1203, a first signal receiving end 1204, a second signal transmitting end 1205, and a second signal receiving end 1206 are respectively disposed on the PCBA board. The PCBA board 1202 is fixed to the fixing piece, and the sensing assembly is fixed to the laser. The first signal transmitting end and the first signal receiving end are disposed opposite to each other and are on a same horizontal line. The second signal transmitting end and the second signal receiving end are disposed opposite to each other and are on the same horizontal line. A gap is defined between the two signal transmitting ends and the two signal receiving ends, and the sensing stopper 1004 is placed within the gap.

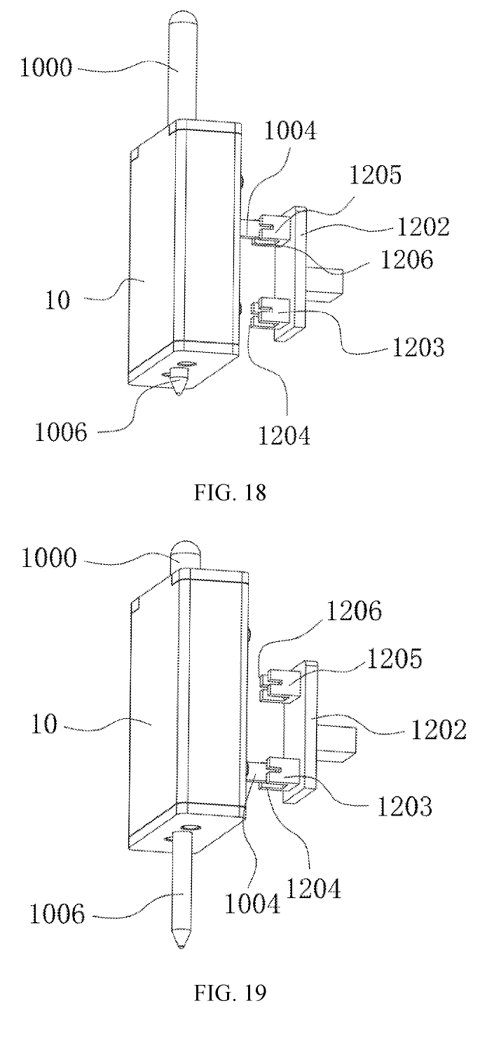

Since the sensing stopper moves synchronously up and down with the probe shaft, the movement of the probe shaft 1006 is determined by a movement of the sensing stopper 1004. The first signal transmitting end 1203 and the first signal receiving end 1204 are positioned below the second signal transmitting end 1205 and the second signal receiving end 1206. As shown in FIG. 18, when the probe assembly is in the retracted state, the sensing stopper 1004 is positioned between the second signal transmitting end and the second signal receiving end to block signal transmission and reception of the second signal transmitting end and the second signal receiving end, while the first signal transmitting end and the first signal receiving end function normally. At the moment, the probe assembly is in the retracted state. As shown in FIG. 19, the sensing stopper 1004 is positioned between the first signal transmitting end and the first signal receiving end to block signal transmission and reception of the first signal transmitting end and the first signal receiving end, while the second signal transmitting end and the second signal receiving end function normally. At this moment, the probe assembly is in the extended state. It should be noted that more signal transmitting ends and signal receiving ends may be provided to handle a case that the probe assembly has variable extension length and the plurality of positioning points are defined in the probe assembly.

The sensing assembly 12 works in conjunction with the distance detection device 10. When the probe shaft 1006 extends to make the sensing stopper 1004 being located in a first signal assembly (i.e., the first signal transmitting end and the first signal receiving end), a main program is noticed that the probe shaft 1006 is in the extended state. Then the laser continues to descend. When the probe shaft contacts the processing surface of the workpiece, the probe shaft is supported vertically upward by the workpiece, causing the probe shaft to move upward. The probe shaft then drives the sensing stopper 1004 to move upward and disengage from the first signal assembly. A signal change of the first signal assembly is fed back to the main program. At this time, the main program obtains a feedback signal of the first signal assembly, which indicates that the position of the processing surface of the workpiece is detected, and the main program records a Z-axis height of the processing surface of the workpiece. A position detection of a single-point height of the engraved workpiece (i.e., the workpiece) is completed. Then the laser is adjusted to the optimal distance again, and the probe shaft is retracted. Based on height information of the surface to be engraved of the workpiece, the main program automatically calculates an optimal engraving position of the laser according to an engraving focal length. After the laser moves to the optimal engraving position, the engraving operations are performed.

As shown in FIGS. 18-19 and 22-23, two photoelectric sensors are disposed vertically along the Z-axis direction inside the sensing assembly12. The sensing assembly12 is fixed inside the laser 2, and a through groove structure corresponding to the two photoelectric sensors is defined on one side of the laser 2. The sensing stopper 1004 passes through the through groove structure and moves vertically along the Z-axis direction. When the probe shaft 1006 extends to different extension lengths, the sensing stop 1004 is in different positions, which triggers the two photoelectric sensors inside the sensing assembly12, allowing the main program to identify the extended state and the retracted state of the probe shaft. When the sensing stopper 1004 triggers a first photoelectric sensor disposed above the sensing assembly12, the first photoelectric sensor informs the main program that the probe shaft is in the retracted state. When the sensing stopper 1004 triggers a second photoelectric sensor disposed below the sensing assembly12, the second photoelectric sensor informs the main program that the probe shaft is in the extended state. A critical point when the sensing stopper 1004 changes from a triggered state to an untriggered state from the second photoelectric sensor below the sensing assembly12 indicates that the surface to be engraved of the workpiece has been detected.

The embodiment further provides a processing device. The processing device comprises the distance detection device described above. Specific details of the distance detection device are as described above and are not repeated herein. The distance detection device is applied to laser processing equipment such as a laser engraving machine, a laser cutting machine, and a laser marking machine. Alternatively, the distance detection device is applied to processing equipment such as a printer that requires detecting a surface height of the workpiece. The distance detection device is configured to detect the distance between a processing head and a processing position of the processing equipment, or to detect a flatness of the processing surface of the workpiece.

For example, in laser engraving equipment, the processing head is commonly configured as a laser engraving head that emits engraving laser. The distance detection device is applied to detect the position of the processing surface of the workpiece, an engraving position of the laser engraving head is calculated based on a focal length to ensure optimal engraving effects. The distance detection device is also configured to detect the flatness of the processing surface and generate surface curvature information of the workpiece to realize variable height multi-point detection. When detecting the distance between the laser engraving head and the processing surface of the workpiece, the probe shaft in the retracted state is aligned with a laser output port of the laser engraving head. In this case, the distance detected by the probe assembly is an actual distance between the laser engraving head and the processing surface of the workpiece, and the laser engraving head is focused based on the distance. Alternatively, the probe shaft in the retracted state is not aligned with the laser output port of the laser engraving head. In this case, a height difference between the probe shaft and the laser output port is recorded, and distance compensation needs to be performed when calculating the actual distance. Then, the focus length is adjusted based on a compensated distance. The embodiment does not impose any limitations on the height difference of the probe shaft in the retracted state and the laser output port, which is determined according to actual needs.

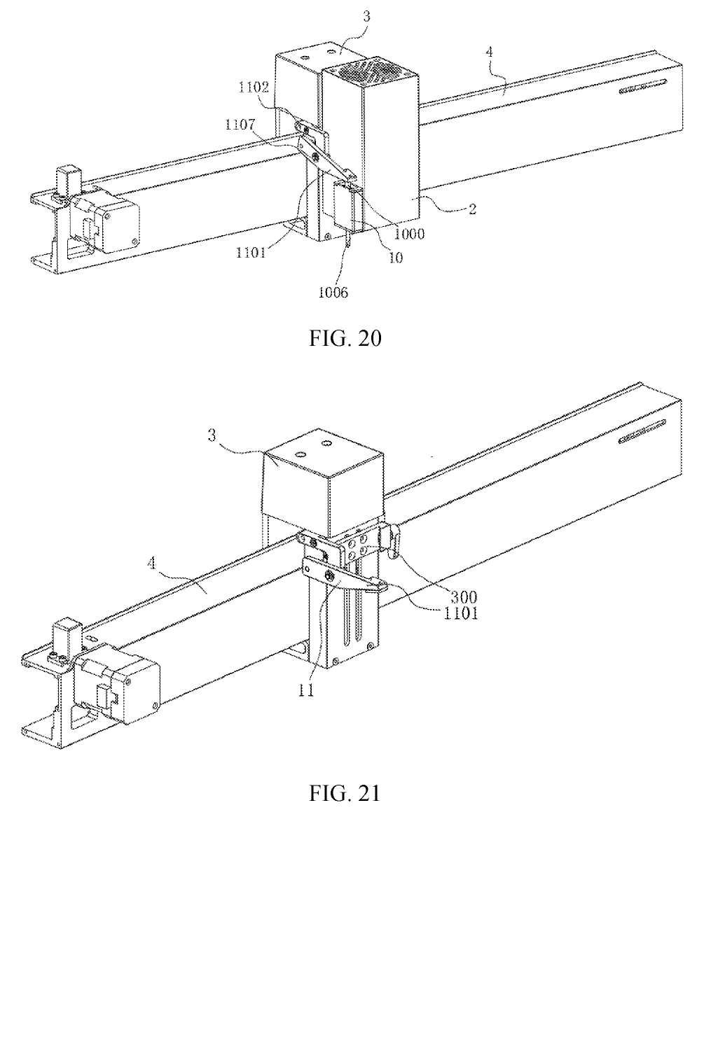

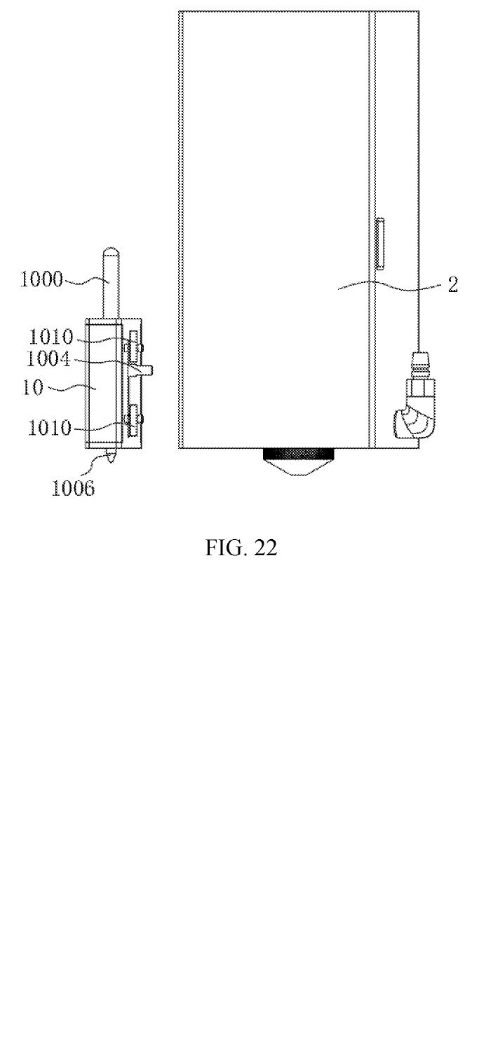

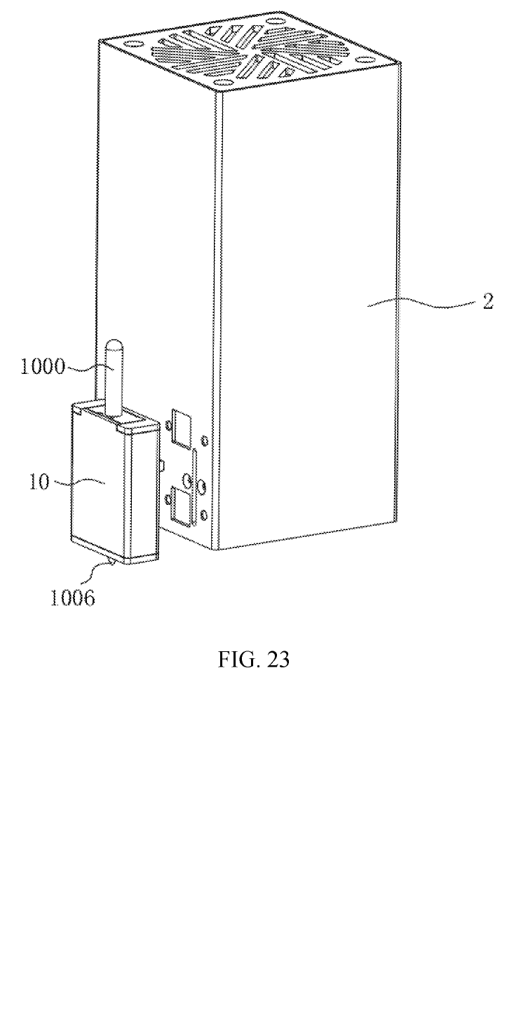

Furthermore, as shown in FIG. 20-21, the pressing assembly 11 is mounted on the Z-axis moving device 3, and the sensing assembly 12 is mounted inside the laser 2. As shown in FIG. 22-23, the probe assembly 10 is then attracted to the laser 2 through the magnets 1010. An attraction area is defined on the laser to facilitate the mounting of the probe assembly, and the magnetic connection also facilitates disassembly and assembly. Further, the magnets allow the probe assembly to be mounted on different lasers. The laser with the probe assembly 10 and the sensing assembly 12 is fixed to a laser connecting block. Alternatively, other easily disassembled structures are provided to connect the probe assembly 10 to the laser for easy replacement and installation, such as snapping fasteners or screws.

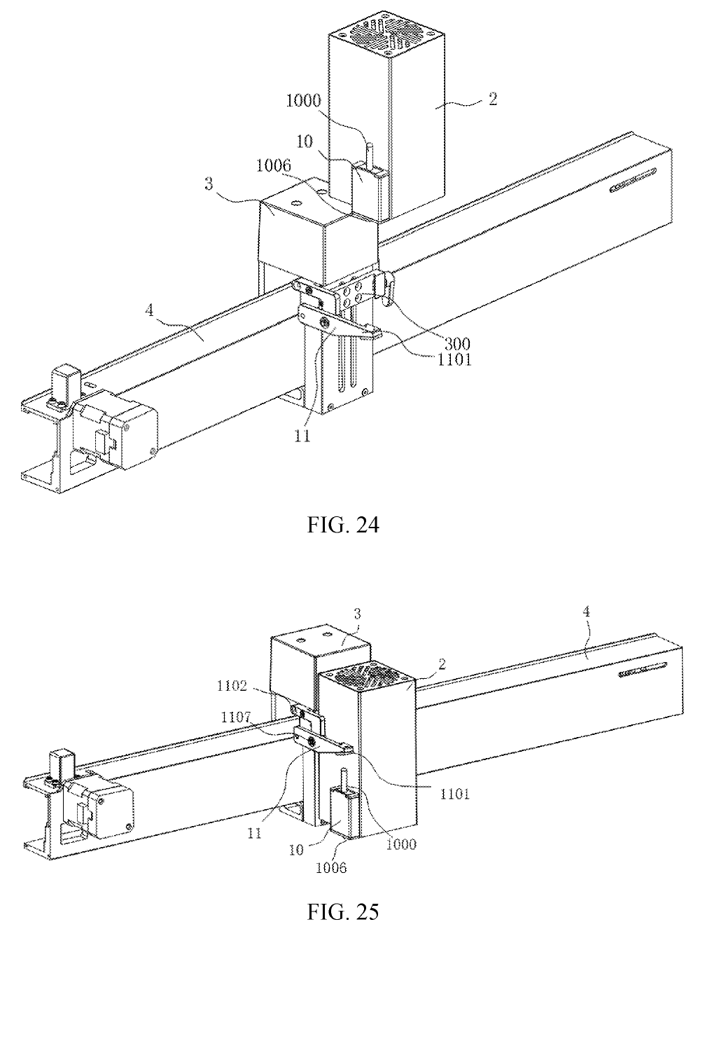

Furthermore, as shown in FIG. 24, the laser is fixed to the Z-axis moving device through the laser connecting block 300. A Z-axis motor of the laser drives the Z-axis moving device to move up and down along the Z-axis. The Z-axis moving device and the laser connecting block 300 move synchronously, thereby causing the laser connecting block 300 to move up and down along the Z-axis.

When using the processing device, a user fixes the probe assembly 10 to the laser. The main program executes following actions. First, the laser 2 is reset to an initial position (X=0, Y=0, Z=0). During a reset process, the laser is first raised to reset to an initial Z-axis position (Z=0), and then the laser is reset to an initial X-axis position and an initial Y-axis position (X=0, Y=0). Two scenarios may occur at this time.

In a first scenario, when the probe shaft is in the retracted state and the main program resets the laser to the initial Z-axis position, the laser 2 is raised to the initial Z-axis position (Z=0). During a first raising process, the probe assembly 10 contacts the pressing assembly 11, and the pressing assembly 11 continuously presses the probe assembly 10. After the laser reaches a highest position and the initial Z-axis position, the laser lowers a short distance and releases the probe shaft 1006. The probe shaft 1006 is now in the extended state. At this time, the sensing stopper 1004 triggers the second photoelectric sensor disposed inside the sensing assembly 12, and the main program is noticed that the probe shaft is in the extended state based on the feedback signal from the first photoelectric sensor. In the situation, the main program does not continue to execute the X-axis and Y-axis reset actions because moving the laser with the probe shaft in the extended state might scratch the workpiece being engraved. Then, the main program raises the laser back to the initial Z-axis position. During a second raising process, the probe assembly 10 contacts the pressing assembly 11, and the pressing assembly 11 continuously presses the probe assembly 10. After the laser reaches the highest position and completes the reset action in the Z-axis, the laser descends a short distance and releases the probe shaft. The probe shaft 1006 is now in the retracted state. At this time, the sensing stopper 1004 triggers the first photoelectric sensor disposed inside the sensing assembly 12. The main program then determines that the probe shaft is in the retracted state based on the feedback signal from the first photoelectric sensor. Subsequently, the main program continues to drive the laser back to the initial X-axis position and the initial Y-axis position (X=0, Y=0), thereby realizing the rest of the laser to the initial position (X=0, Y=0, Z=0).

In a second scenario, when the probe shaft 1006 is in the extended state and the program needs to reset the laser to the initial Z-axis position, the laser 2 is first raised to the initial Z-axis position. During the first rising process, the probe assembly 10 contacts the pressing assembly 11, and the pressing assembly 11 continuously presses the probe assembly 10. After the laser reaches the highest position and completes the reset action in the Z-axis, the laser descends a short distance and releases the probe shaft. The probe shaft is now in the retracted state. At this time, the sensing stopper 1004 triggers the first photoelectric sensor disposed inside the sensing assembly 12. The main program then determines that the probe shaft is in the retracted state based on the feedback signal from the first photoelectric sensor. Subsequently, the main program continues to drive the laser back to the initial X-axis position and the initial Y-axis positions, realizing the initial position reset function of the processing device. The laser connecting block 300 is fixed to the movable block 3001. Since the laser connecting block 300 and the laser 2 are fixed together, the movable block 3001 moves synchronously with the laser 2. When an engraving command is received, as the laser 2, equipped with the probe assembly 10, moves vertically upward along the Z-axis direction, the movable block 3001 also moves vertically upward. When the movable block contacts the bearing 1104 of the pressing assembly 11, as shown in FIG. 20, the movable block drives the rotating block 1101 to rotate clockwise around the first rotating shaft 1107. Subsequently, the rotating block 1101 contacts the pressing shaft 1000 and exerts the pressing force on the pressing shaft 1000.

As shown in FIG. 20, when the pressing shaft 1000 moves downward, causing the sliding block 1003 to move vertically downward, the pressing shaft 1000 pushes the sliding block 1003 of the probe assembly 10 to the lowest point thereof. The second compressing springs 1008 are compressed, and simultaneously, the probe hook 1005 of the probe assembly moves relative to the sliding block 1003 to the first high point of the hook sliding groove 1012. At this moment, after the laser 2 reaches the highest point thereof and triggers a sensing switch, the laser 2 and the movable block 3001 continue to move downward. The external force exerted by the movable block 3001 on the bearing 1004 of the pressing assembly 10 disappears, and the rotating block 1101 disengages from the pressing shaft 1000 of the probe assembly 10 under the restoring force of the torsion spring 1103. The sliding block 1003 moves upward under the restoring force of the second compressing springs 1108. At this time, the second end of the probe hook moves relative to the sliding block 1003 to the positioning point of the hook sliding groove 1012. The sensing stopper 1004 is located between the first signal transmitting end 1203 and the first signal receiving end 1204, blocking the signal transmission and reception of the first signal assembly. The second signal transmitting end 1205 and the second signal receiving end 1206 are not blocked and function normally, indicating that the probe shaft 1006 of the probe assembly 10 is in the extended state. Under the restoring force of the first compressing spring 1007, the probe shaft 1006 elastically moves in the central hole of the sliding block 1003. At this time, the probe shaft is configured to detect the position of the processing surface of the workpiece. During the detection process, due to the aforementioned actions, the probe shaft 1006 is in the extended state, and the sensing stopper 1004 is disposed in the first signal assembly. The laser continues to descend until the probe shaft contacts the processing surface of the workpiece. During the continued descent, the probe shaft moves upward under the thrust from the processing surface of the workpiece, driving the sensing stopper 1004 upward, so that the sensing stopper disengages from the first signal assembly. At this point, the processing surface of the workpiece is detected, and a Z-axis height of the processing surface of the workpiece is recorded. In this way, the distance between the laser engraving head and the processing surface of the workpiece is determined. Once the distance detection is completed, the main program drives the movable block to move vertically upward. Subsequently, the movable block 3001 contacts the bearing 1104 of the pressing assembly 11, causing the rotating block to rotate clockwise around the first rotating shaft 1107. Then, the rotating block 1101 contacts the pressing shaft 1000 again, causing the sliding block 1003 to move vertically downward. In this way, the sliding block 1003 of the probe assembly 10 is pushed to the lowest point thereof. At this time, the movable end of the probe hook 1005 moves relative to the sliding block 1003 in the hook sliding groove 1012 until the movable end of the probe hook reaches the second high point. At this moment, the second compressing springs are in the compressed state. Simultaneously, when the laser 2 moves to the highest point thereof, the laser triggers the sensing switch, and then the laser 2 moves downward. The laser 2 and the movable block 3001 continue to move downward until the external force applied by the movable block 3001 to the bearing 1004 of the pressing assembly 10 disappears. The rotating block 1101 disengages from the pressing shaft 1000 of the probe assembly 10 under the restoring force of the torsion spring 1103. The sliding block 1003 moves upward after being subjected to the rebound force of the second compressing springs 1108 in the compressed state. The probe hook 1005 moves relative to the sliding block 1003 in the hook sliding groove 1012 under the force and moves along the hook sliding groove 1012. After moving to the initial position, the sensing stopper 1004 is disposed between the second signal transmitting end 1205 and the second signal receiving end 1206, blocking the signal transmission and reception of the second signal assembly. The first signal transmitting end 1203 and the first signal receiving end 1204 are not blocked and function normally. At this time, the probe shaft 1006 of the probe assembly 10 is in the retracted state, the laser calculates the optimal engraving position in the Z-axis and the focal length based on the previously recorded detection point, then the laser moves to the optimal engraving position for processing. After processing at the detection point, the laser moves to other positions and repeatedly applies force to the bearing 1104 through the vertical movement of the movable block 3001, causing the rotating block 1101 to rotate and apply pressing force to the pressing shaft 1000, thereby driving the sliding block 1003 to move vertically and linearly. Then, by moving the probe hook 1005 to various positions in the hook sliding groove 1012, the sliding block 1003 is repeatedly pressed, causing the probe shaft 1006 to extend and retract under the external forces in the same direction. Therefore, it avoids the distance detection device extending and retracting at different X-axis and Y-axis positions, reducing movement time and improving work efficiency. Moreover, it allows for the resetting of the pressing assembly at the engraving position, eliminating a need for the probe shaft to contact the processing surface of the workpiece for reset, thus preventing damage to the processing surface of the workpiece from repeated contact and affecting subsequent processing. The above description is merely an optional embodiment of the present disclosure and does not limit the patent scope of the present disclosure. Any equivalent structural transformations made based on the concept of the present disclosure, utilizing the description and drawings, or direct/indirect applications in other related technical fields are comprised within the patent protection scope of the present disclosure.

The distance detection device of the present disclosure is able to determine the optimal engraving position of the laser of the laser engraving machine, ensuring that good engraving results are realized at the laser focus. When the distance detection device is at initial position (X=0, Y=0, Z=0) and the probe shaft is in the retracted state, the laser and the distance detection device move to the coordinates in the X-axis direction and the Y-axis direction according to commands, while the Z-axis moving device moves upward and returns to the initial Z-axis direction. The state of the probe shaft is then detected. When the probe shaft is in the extended state, the probe shaft is able to detect the position of the processing surface of the workpiece, so that laser focusing is allowed to be completed. When the probe shaft is in the retracted state, the Z-axis moving device moves upwards and returns to the initial Z-axis position. The probe shaft is pressed for releasing, so that the probe shaft extends. At this point, the probe shaft is able to detect the position of the processing surface of the workpiece and complete the laser focusing. After laser focusing is complete, the state of the probe shaft is detected again. When the probe shaft is in the extended state, the Z-axis moving device moves upwards and returns to the initial Z-axis position. The probe shaft is pressed to retract, and the laser starts operations. When the probe shaft is in the retracted state, the laser directly starts operations. After the operations are completed, the position of the probe shaft is detected. When the probe shaft is in the retracted state, the laser returns to the initial position. When the probe shaft is in the extended state, the laser moves upwards along the Z-axis to return to the initial Z-axis position. When the probe shaft is pressed down to retract, the laser returns to the initial position. The probe shaft is only in the extended state when probing, and the probe shaft is in the retracted state during non-probing operations and movement.

An engraving process from the initial position to a specific position within the working area is as follows. After resetting to the initial position, the main program drives the laser 2 to a designated engraving position (the laser reaches the designated engraving position in the X-axis and the Y-axis, and the designated engraving position in the Z-axis is below the initial Z-axis position after resetting). At this time, the probe shaft 1006 is in the retracted state. The main program drives the laser 2 to rise along the Z-axis direction. After the laser reaches the highest position thereof and completes the reset action in the Z-axis, the laser descends a short distance and releases the probe shaft. The probe shaft 1006 is now in the extended state. At this time, the sensing stopper 1004 triggers the second photoelectric sensor disposed inside the sensing assembly 12, and the main program is noticed that the probe shaft is in the extended state based on the feedback signal from the first photoelectric sensor. Then, the laser is lowered further until the probe shaft contacts the processing surface of the engraved workpiece. Then, the laser is lowered further to make the probe shaft abut against the processing surface of the engraved workpiece. A contact point on the processing surface of the engraved workpiece pushes the probe shaft upwards, causing the sensing stopper 1004 to block a constant signal received by the second photoelectric sensor. The constant signal is switched to a changed signal and is fed back to the main program, so that the height of the processing surface of the engraved workpiece is detected.

When more than one detection point needs to be detected, after detecting a first detection point, the laser rises to a certain height (a position where the pressing assembly 11 and the pressing shaft 1000 are not under the pressing force) and then continues to descend, detecting and recording the position information of a second detection point. The operations are repeated until all detection points are detected. Then, the laser rises to the initial Z-axis position and descends a short distance to release the probe shaft. The probe shaft is now in the retracted state. At this time, the sensing stopper 1004 triggers the first photoelectric sensor disposed inside the sensing assembly 12, and the main program determines that the probe shaft is in the retracted state based on the feedback signal from the first photoelectric sensor. Then, the main program generates the height information of the processing surface (flat/curved surface) of the workpiece according to the recorded positions of all of the detection points on the processing surface of the workpiece. The main program then automatically calculates the optimal engraving position and the Z-axis position of the laser based on the height information and the focal length of the laser. Finally, the laser starts engraving to complete one engraving process.

Furthermore, the distance detection device is also able to detect the flatness of the processing surface of the workpiece based on the distance detection of the workpiece. After obtaining the height of a first position of the processing surface of the workpiece by performing the aforementioned steps, as shown in FIG. 27, the height of a second position of the processing surface of the workpiece is obtained by driving a belt 41 to rotate through a motor 40 and moving the laser to other positions. If the height at the first position is different from the height of the second position, it is determined that the processing surface of the workpiece is not placed horizontally.

### Embodiment 2

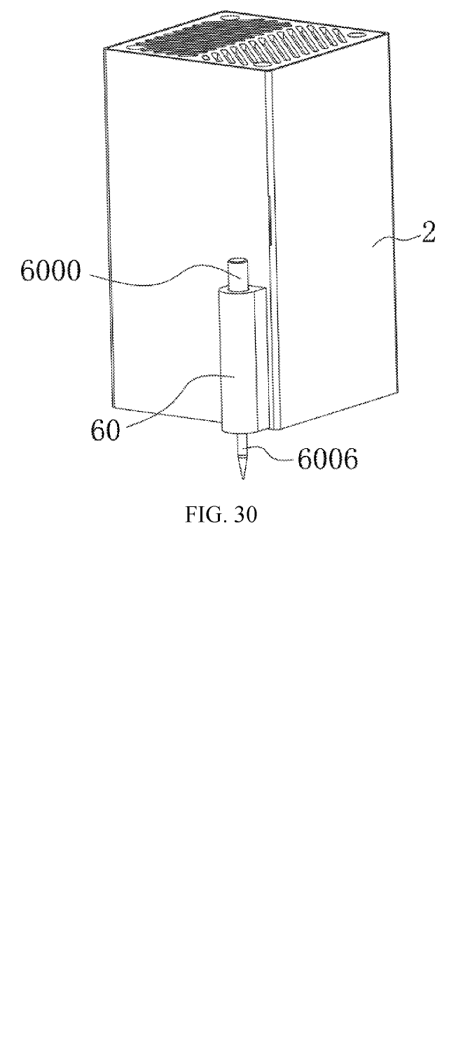

The embodiment provides a distance detection device and a distance detection method. As shown in FIG. 30, a probe assembly 60 is fixed to a laser 2. By applying a pressing force to a pressing shaft 6000, the probe shaft 6006 is extendable and retractable under an action of external forces in the same direction.

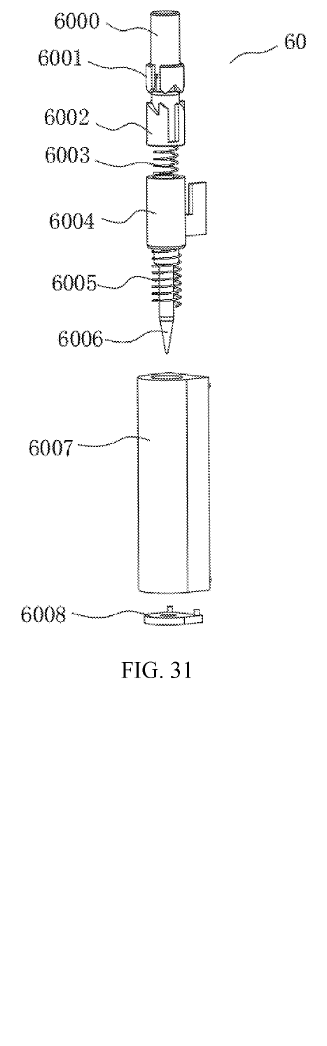

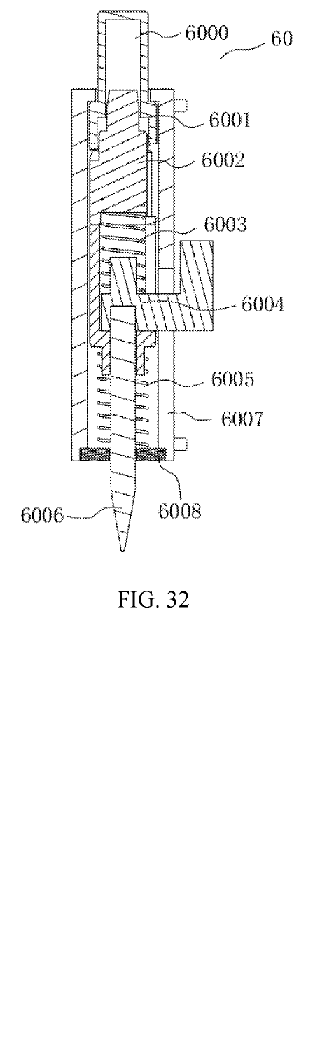

Further, as shown in FIG. 31-32, the probe assembly 60 comprises a housing 6007. A through hole is defined inside the housing 6007. A probe shaft 6006 and a second compressing spring 6005 sleeved on an outer side of the probe shaft are disposed in the through hole. A probe base plate 6008 is disposed at a lower end of the housing, and the probe base plate fixes the second compressing spring to the housing 6007. A central hole is defined in a center of the probe base plate, and the probe shaft is allowed to move in the central hole to change an extension length thereof. When the second compressing spring 6005 is compressed, the second compressing spring 6005 applies an upward rebound force to a sensing stopper 6004, thereby ensuring tight contact between a locking piece 6002 and the pressure rod 6001. An upper end of the probe shaft 6006 is connected to the sensing stopper 6004. The second compressing spring is disposed between the sensing stopper and the probe base plate, and the housing comprises a groove for a movement of the sensing stopper. The sensing stopper partially passes through the groove and moves between the sensing assembly in Embodiment 1 to detect a movement state of the probe assembly. The specific detection method is the same as described above and is not repeated herein. A first compressing spring 6003 is connected to an upper end of the sensing stopper, and a locking piece 6002 is connected to an upper end of the first compressing spring 6003. A pressing shaft 6000 is integrally connected to an upper end of the pressing rod 6001. The pressing shaft 6000 passes through the through hole from an upper end of the housing and contacts the probe assembly to realize a pressing movement. When the pressing shaft is subjected to an external force and moves downward, the pressing shaft drives the probe pressing rod to move downward and pushes the locking piece to move downward. The second compressing spring is compressed and generates the upward rebound force on the sensing stopper and pushes the probe shaft to move upward. A specific movement mode thereof is the same as that in Embodiment 1, which is not repeated herein.

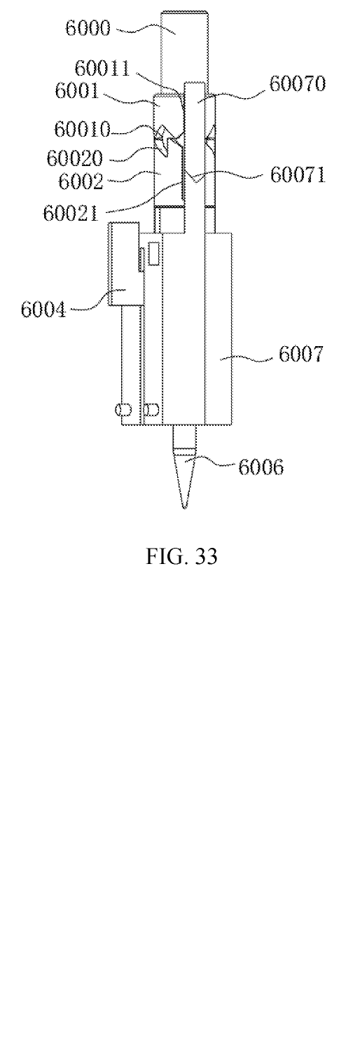

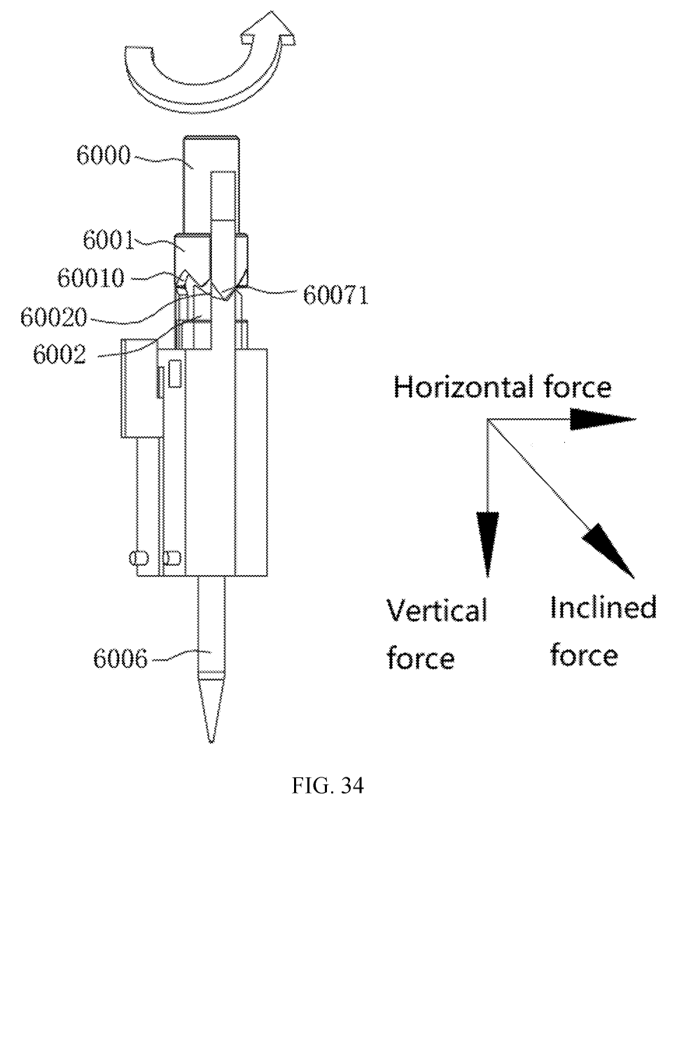

Furthermore, as shown in FIG. 31-34, the pressing rod 6001 defines a pressing rod groove 60011 on one side thereof. The locking piece defines a locking piece groove 60021 on one side thereof, and the locking piece groove is corresponding to the pressing rod groove. A housing boss 60070 corresponding to the pressing rod groove and the locking piece groove is defined on an inner wall of the housing. After applying the pressing force to the pressing shaft, the housing boss is movable up and down relative to the pressing rod groove and the locking piece groove. To realize locking after rotation, a lower end of the pressing rod 6001 has pressing rod slopes 60010, and the upper end of the locking piece 6002 defines locking piece slopes 60020. When the pressing shaft moves downwards under the pressing force, the pressing rod slopes generate an inclined force on the locking piece slopes. This inclined force is decomposed into a vertical force and a horizontal force. The vertical force drives the locking piece to move vertically downwards, and the horizontal force drives the locking piece to rotate. However, because the housing boss is located at the locking piece groove, the locking piece is unable to rotate in a horizontal direction, so the locking piece is only allowed to move downwards in a vertical direction. When the housing boss 6007 moves below the locking piece groove, the horizontal force is applied to make the locking piece rotate. In order to fix a position of the locking piece after rotation, the housing boss 60070 comprises an engaging tooth 60071. When the horizontal force makes the locking piece rotate, the engaging tooth is placed below the locking piece to prevent the locking piece from moving in the vertical direction, thereby limiting the position of the locking piece. When the pressing force is continued to be applied to the pressing shaft to make the locking piece rotate, the housing boss rotates to the locking piece groove relative to the locking piece 6002. At this time, the locking piece is movable in the vertical direction, but is unable to rotate in the horizontal direction.

Furthermore, as shown in FIG. 31-34, when the pressing shaft 6000 moves downward under the pressing force transmitted by the pressing assembly, the pressing rod 6001, the locking piece 6002, the sensing stopper 6004, and the probe shaft 6006 all move downward in the housing 6007. The pressing rod groove 60011 and the locking piece groove 60021 slide in the housing boss 60070. The pressing rod slopes 60010 contact the locking piece slopes 60020, applying the inclined force to the locking piece slopes 60020. The inclined force is decomposed into the vertical force and the horizontal force. The vertical force drives the locking piece to move vertically downward. Because the locking piece groove 60021 accommodates the housing boss 60070, the horizontal force is ineffective, and the locking piece 6002 is unable to rotate and is only allowed to move vertically downward. During the continuous downward movement of the locking piece, the second compressing spring 6005 is kept in the compressed state. Then the locking piece groove 60021 gradually disengages from the housing boss 60070. The horizontal force functions and drives the locking piece to rotate. When the locking piece 6002 moves to a lowest point thereof, one of the locking piece slopes 60020 is rotated to a position corresponding to the engaging tooth 60071. After the pressing force on the pressing shaft disappears, the second compressing spring 6005, being in the compressed state, applies the upward restoring force to the locking piece 6002, driving the one of the locking piece slopes 60020 to engage with the engaging tooth 60071. At this time, the probe shaft 6000 is in the extended state.

The first compressing spring connected to the upper end of the probe shaft is configured to adjust the extension length of the probe shaft to realize the detection of the distance between the processing surface of the workpiece and the laser. The specific method is the same as that in Embodiment 1 and is not repeated here. When the pressing force continues to be applied to the pressing shaft 6000, the pressing rod slopes 60010 contacts the locking piece slopes 60020 and applies the inclined force to the locking piece slopes. The inclined force is decomposed into the vertical force and the horizontal force. The vertical force drives the locking piece to move vertically downward. The vertical force drives the locking piece 6002 moves to the lowest point thereof. When the locking piece groove 60021 is rotated to the position corresponding to the housing boss 60070, the second compressing spring 6005 is in the compressed state. At this time, when the pressing force is released, the second compressing spring 6005 resets and applies the upward restoring force to the locking piece 6002, driving the locking piece groove 60021 to move along the housing boss back to an initial position thereof. At this time, the probe shaft 6006 is in the retracted state.

By repeatedly applying the pressing force to the pressing shaft, the extension and retraction of the probe shaft is realized. Cooperating with the aforementioned pressing assembly, it is possible to realize the extension and retraction of the probe shaft by applying different external forces in the same direction. Alternatively, locking piece grooves 60021 are defined on a sidewall of the locking piece 6002, and each of the locking piece slopes 60020 is defined between each two adjacent locking piece grooves, so that the locking piece is allowed to rotate from one of the locking piece grooves to an adjacent locking piece groove each time the pressing shaft is pressed, thereby realizing reset. Angles of the locking piece slopes may be different to realize the probe shaft being positioned at different positions. In this case, the extension length of the probe shaft is not exactly the same, thereby forming the preset groove and the preset positions that different from the preset groove and the preset positions of Rmbodiment 1. The embodiment realizes detection of the processing surfaces with different heights, thus broadening the application of the present disclosure.

### Embodiment 3

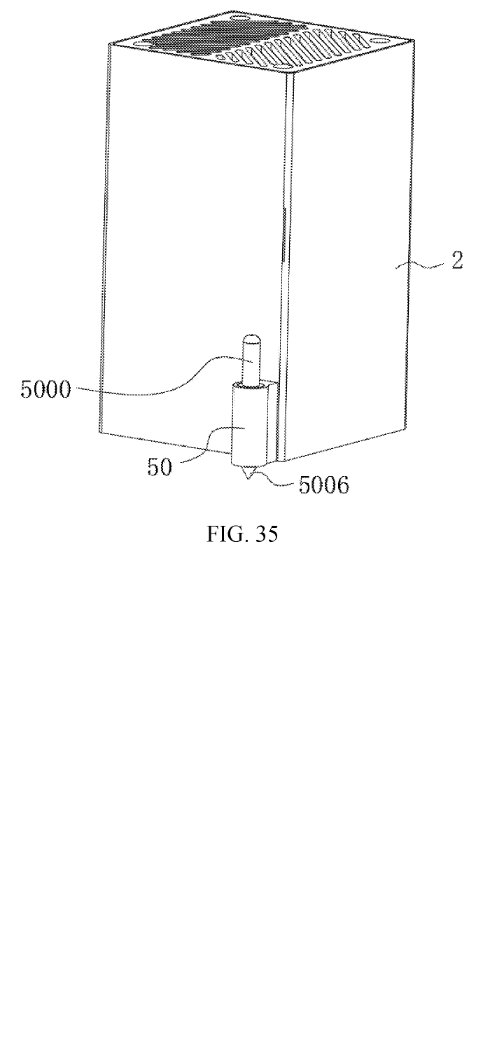

The embodiment provides a distance detection device and a distance detection method. As shown in FIG. 35, a probe assembly 50 is connected to the laser 2. By applying external forces in the same direction to the pressing shaft 5000, the probe shaft 5006 is able to extend and retract.

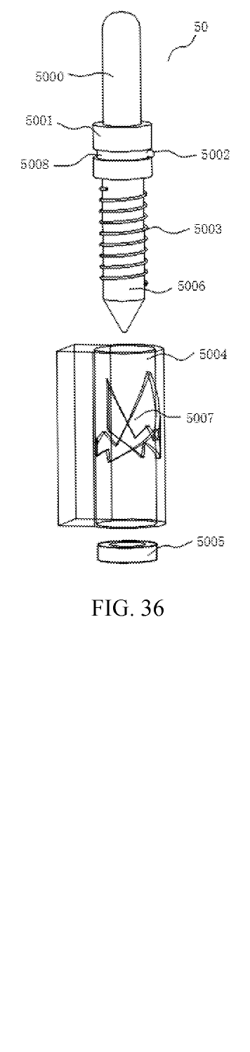

Furthermore, as shown in FIG. 36, the probe assembly 50 comprises a housing 5004. The housing 5004 comprises an upper opening, a lower opening and a movable channel. A probe shaft 5006 is disposed in the housing. A second compressing spring 5003 is sleeved on the probe shaft and is disposed in the housing. A probe base plate 5005 is disposed at the lower opening of the housing. The probe base plate fixes the second compressing spring in the housing. A central hole is defined in a center of the probe base plate, through which the probe shaft extends and retracts. A pressing rod 5001 is connected to an upper end of the probe shaft 5006. An upper end of the pressing rod is connected to the pressing shaft 5000. The pressing shaft passes through the upper opening of the housing and contacts the pressing assembly to realize a pressing movement. When the pressing shaft is subjected to a pressing force and moves downward, the pressing shaft drives the pressing rod downward and pushes the probe shaft downward. A circular annular groove 5008 is defined in a middle portion of the pressing rod 5001. A probe ball 5002 is limited in the circular annular groove. The probe ball is rotatable freely in the circular annular groove. The housing comprises a ball sliding groove 5007 corresponding to the probe ball. When the pressing shaft is subjected to the pressing force and moves downward, the probe ball slides within the ball sliding groove for positioning. Alternatively, the probe ball 5002 is replaced with a fixed protrusion. The fixed protrusion is fixedly connected to the pressing rod 5001 and moves synchronously. Positioning is realized by fixing the fixed protrusion at different positions within the ball sliding groove 5007. However, in the case, the pressing rod and the fixed protrusion rotate while moving up and down within the housing. A configuration of the probe ball enables that the pressing rod only needs to move up and down in the housing.

Furthermore, in the embodiment, the circular annular groove is defined in the middle portion of the pressing rod 5001, and the probe shaft is connected to a sensing stopper and a sensing assembly to detect the state of the probe shaft. Moreover, an upper end of the probe shaft is connected to a first compressing spring (not shown in the figures), thereby realizing, an effect as described in Embodiments 1 and 2, that the distance detection of the processing surface of the workpiece is realized by compressing the first compressing spring when the probe shaft is in the extended state. A specific working mode may refer to Embodiments 1 and 2, which are not specifically described in the embodiment.

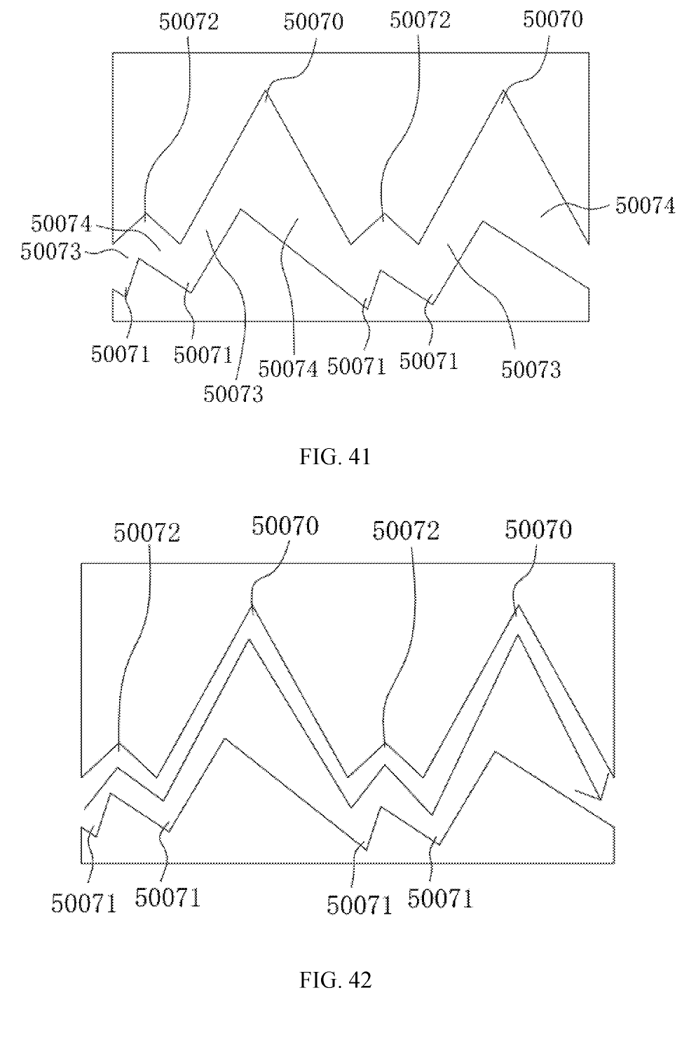

Furthermore, as shown in FIGS. 41-42, the embodiment provides preset grooves and preset positions that are different from those in the above embodiments. The ball sliding groove 5007 defines high points 50070, transition points 50071, and low points 50072. The ball sliding groove further comprises ascending sections 50073 and descending sections 50074. Two ends of each of the ascending sections 50073/descending sections 50074 are respectively a corresponding one of the transition points 50071 and a corresponding one of the high points 50070 the low points 50072. The probe ball may fall vertically from any one of the high points or the low points and land in a corresponding one of the descending sections and move to a corresponding one of the transition points 50071. The height of each of the high points 50070 is greater than a height of each of the low points 50072. The height of each of the high points 50070 and the height of each of the low points 50072 are greater than a height of each of the transition points 50071. Heights of the high points are different or are not exactly the same. Heights of the low points are different or are not exactly the same, so that the extension lengths of the probe shaft are not exactly the same at different high points and low points.

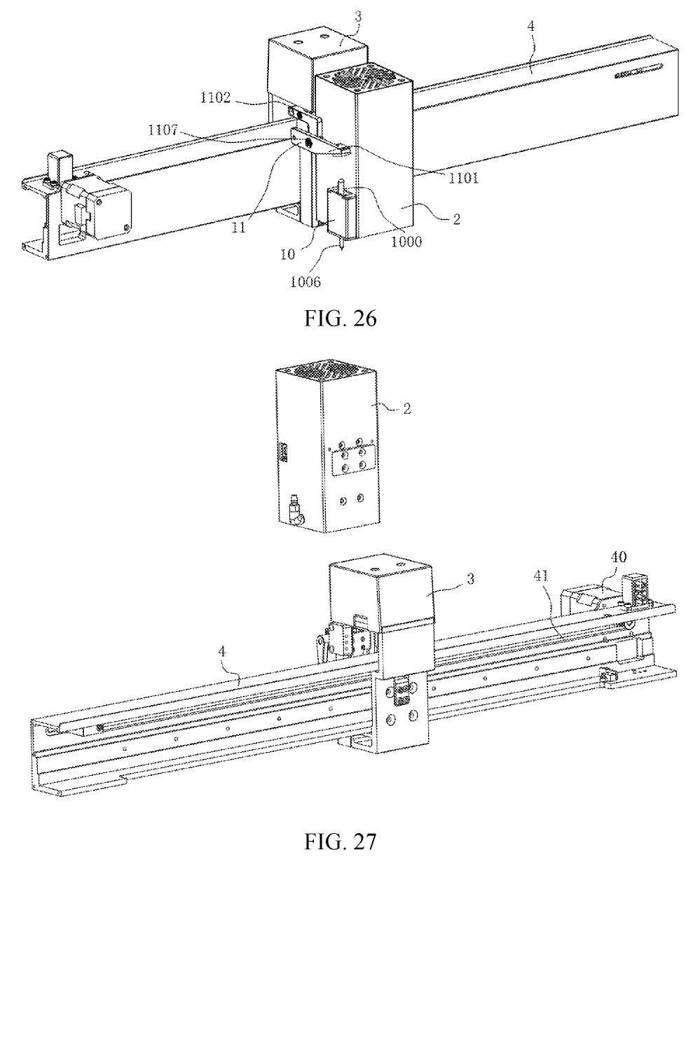

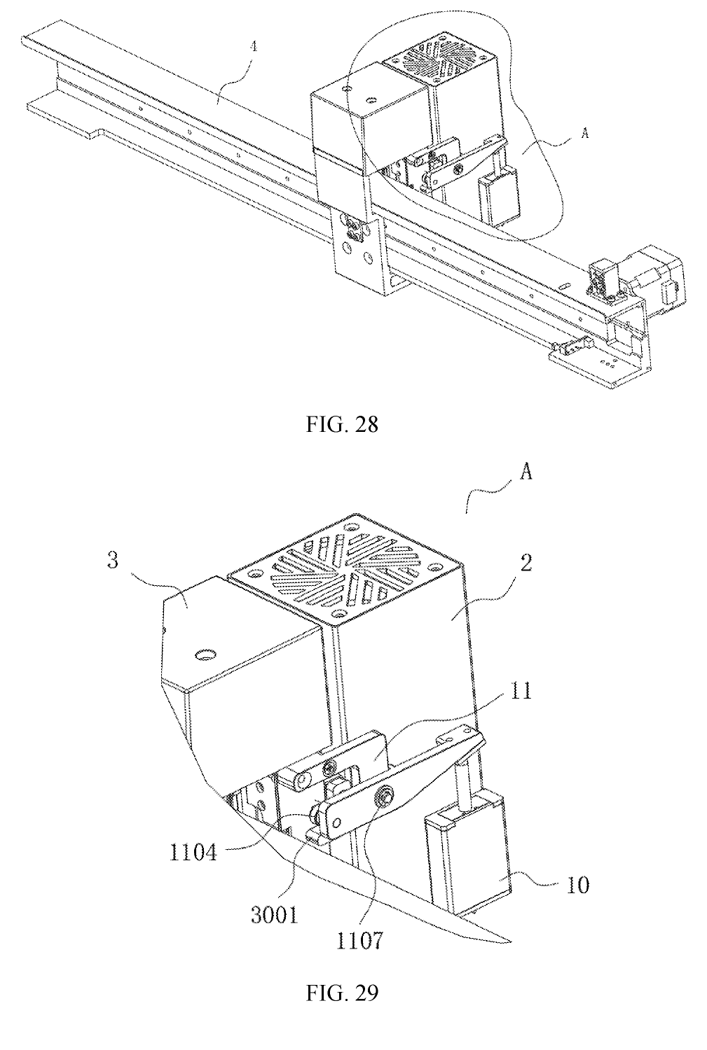

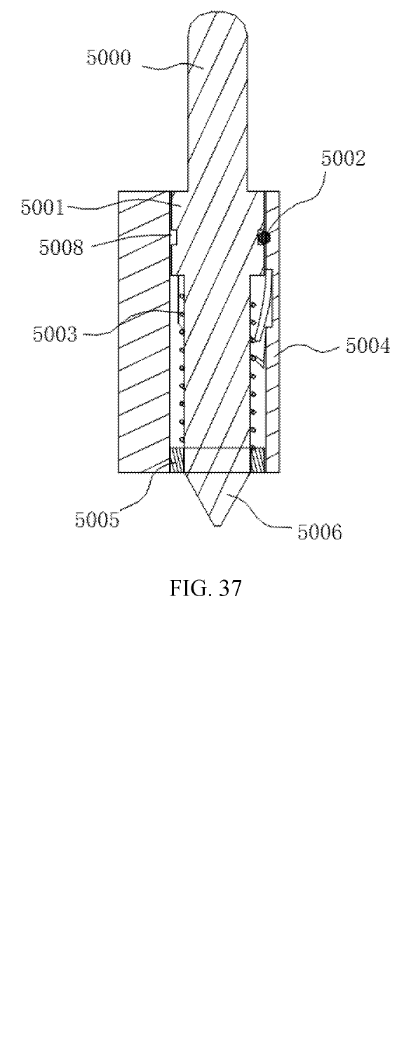

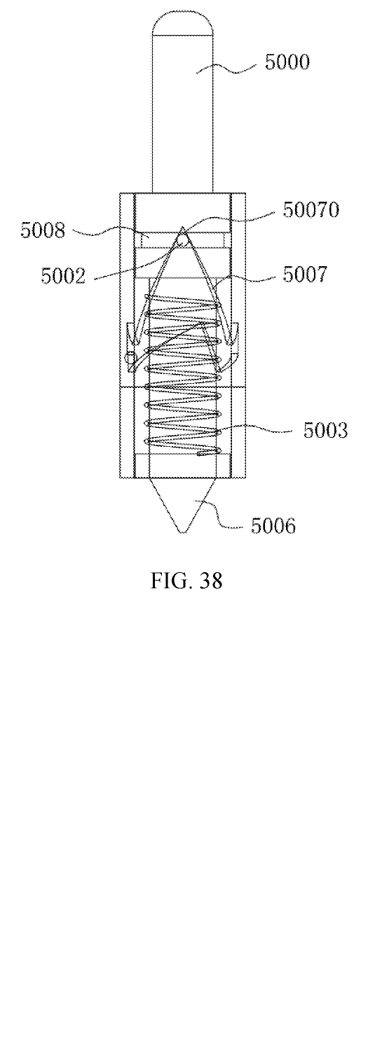

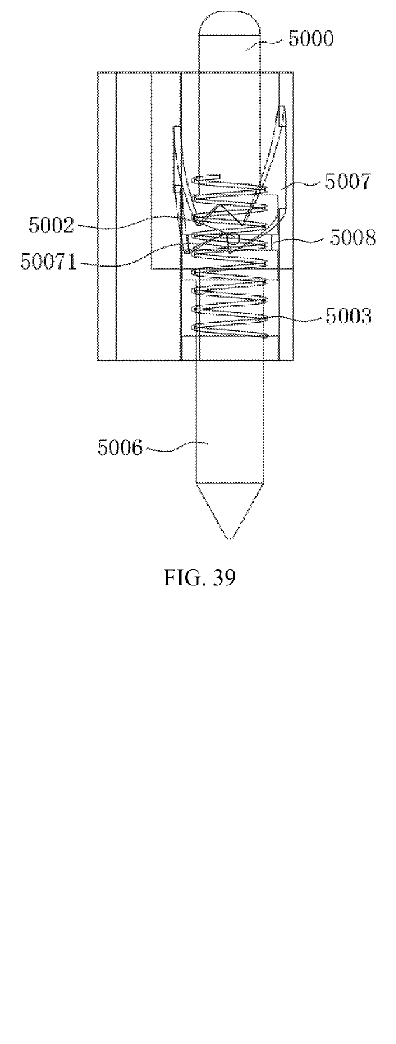

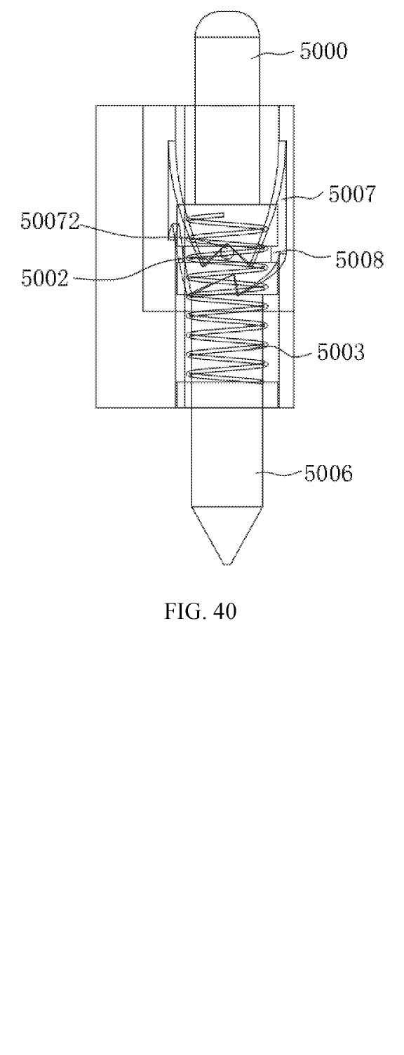

Furthermore, as shown in FIG. 7-42, in the initial state, the probe shaft 5006 is in the retracted state, the pressing shaft 5000 is in a maximum extended state, and the probe ball 5002 is positioned at one of the high points 50070. When the pressing shaft 5000 is subjected to the pressing force and moves vertically downward, the pressing shaft 5000 drives the pressing assembly 5001 to move downward. At this time, the probe ball 5002 also moves downward vertically until the probe ball 5002 contacts a corresponding one of the descending sections 50074. After that, the probe ball moves along the corresponding one of the descending sections 50074 until the probe ball reaches a corresponding one of the transition points 50071. That is a lowest point. At this moment, the probe shaft 5006 extends to the maximum extended state, and the second compressing spring is in the retracted state. When the pressing force on the pressing shaft is released, the second compressing spring 5003 resets and provides a vertically upward restoring force to the pressing rod. The probe ball 5002 also moves vertically upward until the probe ball contacts a corresponding one of the ascending sections 50073. Subsequently, the probe ball moves along the corresponding one of the ascending sections until the probe ball reaches a corresponding one of the low points 50072. At this moment, the probe shaft 5006 is in the extended state, and the distance between the processing surface of the workpiece and the laser is detected by compressing the first compressing spring through the probe shaft. When the pressing shaft 5000 is again subjected to a vertically downward pressing force, causing the pressing rod 5001 to move downward, the probe ball 5002 also moves vertically downward until the probe ball contacts another one of the descending sections 50074. Subsequently, the probe ball moves along the corresponding one of the descending sections until the probe ball reaches another one of the transition points 50071. At this moment, the second compressing spring is in the compressed state. After the pressing force of the pressing shaft 5000 is released again, the second compressing spring 5003 resets and applies the vertically upward restoring force to the pressing rod. The probe ball 5002 also moves vertically upward until the probe ball 5002 reaches another one of the ascending sections 50073. Then, the probe ball moves along the another one of the ascending sections and reaches another one of the high points 50070. The probe shaft is in the retracted state. In this way, the probe ball circulates in a groove wall of the ball sliding groove, and with the pressing assembly, the probe shaft is extendable and retractable under an action of the external forces in the same direction.

What is claimed is:

1. A distance detection device, comprising:
a housing;
a pressing shaft; and
a detector;
wherein a through hole is defined in a lower end of the housing, the pressing shaft and the detector are disposed in the housing, and the pressing shaft is movable along a length direction of the pressing shaft;
wherein a slider is connected to a lower end of the pressing shaft, the slider is movable along with the pressing shaft to push the detector to move, and the detector is capable of passing through the through hole to move along a length direction of the detector;
wherein the housing defines preset positions, and when external forces in the same direction are applied to the distance detection device, the slider moves in the housing to different preset positions to change a length of the detector extending out of the housing.

2. The distance detection device according to claim 1, wherein elastic pieces are disposed in the housing, the elastic pieces are deformed under an action of the slider, and the slider is capable of moving to different preset positions in the housing under the external forces applied to the distance detection device and a force of the elastic pieces, so as to change the length of the detector extending out of the housing.

3. The distance detection device according to claim 2, wherein at least one preset groove is defined in the housing, the preset positions are formed in the at least one preset groove; and the distance detection device further comprises a positioning piece movable in the at least one preset groove, wherein when the slider moves, the positioning piece is movable to different preset positions in the housing, the length of the detector extending out of the housing is fixed or variable.

4. The distance detection device according to claim 3, wherein the preset positions comprise high points, low points, and intermediate points;
wherein the high points, the intermediate points and the low points are sequentially disposed in the at least one preset groove, the intermediate points are disposed between the low points and the high points, and the at least one preset groove is disposed in a loop.

5. The distance detection device according to claim 3, wherein the positioning piece is disposed in the at least one preset groove, the slider and the positioning piece interact with each other, when the slider moves, a position of the positioning piece in the at least one preset groove is changed, and when the positioning piece is placed at any one of the preset positions of the at least one preset groove, the position of the slider is relatively fixed.

6. The distance detection device according to claim 5, wherein the positioning piece is a probe hook, a first end of the probe hook is connected to the housing, a second end of the probe hook is a movable end, the at least one preset groove is disposed on the slider, and the movable end of the probe hook moves in the at least one preset groove of the slider to change a relative position between the detector and the slider.

7. The distance detection device according to claim 5, wherein the positioning piece is an engaging tooth disposed on the housing, the at least one preset groove is defined in the slider and is corresponding to the engaging tooth, and the engaging tooth is capable of being placed at different preset positions of the at least one preset groove to change a position of the detector.

8. The distance detection device according to claim 7, wherein the slider comprises a pressing rod and a locking piece, a lower end of the pressing rod defines pressing rod slopes, and an upper end of the locking piece defines locking piece slopes corresponding to the pressing rod slopes,
wherein the pressing rod slopes of the pressing rod are movable to generate a rotational force on the locking piece slopes of the locking piece to cause the slider to move and change a position of the engaging tooth relative to the at least one preset groove, so as to change the position of the detector.

9. The distance detection device according to claim 5, wherein the positioning piece is a probe ball disposed on the slider, the at least one preset groove is disposed inside the housing, and the probe ball is movable in the at least one preset groove to change a position of the detector.

10. The distance detection device according to claim 3, wherein the elastic pieces comprise a first compressing spring and at least one second compressing spring;
wherein the first compressing spring is disposed between the slider and the detector, or the first compressing spring is embedded in the detector;
wherein the at least one second compressing spring is disposed between the slider and the housing;
wherein the positioning piece is movable to any one of the preset positions in the housing to change the length of the detector extending out of the housing, when the slider moves under the external forces and/or a force of the at least one second compressing spring;
wherein the detector is configured to detect a position of a processing surface of a workpiece by the first compressing spring.

11. The distance detection device according to claim 1, wherein the detector is connected to a sensing stopper, a sensing stopper stroke groove is defined on one side surface of the housing, and the sensing stopper is movable in the sensing stopper stroke groove;
wherein the distance detection device further comprises a sensing assembly corresponding to the sensing stopper, the sensing stopper moves to different positions to trigger the sensing assembly, and the sensing assembly is configured to detect an extended state of the detector.

12. The distance detection device according to claim 11, wherein the sensing assembly comprises a fixing piece and a printed circuit board assembly ( PCBA) board disposed in the fixing piece;
wherein signal assemblies are disposed on the PCBA board along a movement direction of the detector, each of the signal assemblies comprises a signal transmitting end and a signal receiving end, and the probe sensing blocking piece is movable between the signal transmitting end and the signal receiving end of each of the signal assemblies;
wherein when one of signal assemblies fails to function normally, the sensing stopper is positioned between the signal transmitting end and the signal receiving end of the one of the signal assemblies.

13. The distance detection device according to claim 1, wherein the distance detection device further comprises a pressing assembly, and the pressing assembly is capable of exerting an acting force on the pressing shaft to cause the pressing shaft to move.

14. The distance detection device according to claim 13, wherein the pressing assembly comprises a rotating block and a fixing block;
wherein the fixing block is connected to the rotating block through a first rotating shaft, and the rotating block is rotatable relative to the fixing block;
wherein the rotating block comprises a force receiving end and a probe contacting end in contact with the pressing shaft, and the force receiving end of the rotating block is forced to drive the rotating block to rotate, so as to drive the probe contacting end of the rotating block to apply a pressing force to the pressing shaft.

15. The distance detection device according to claim 14, wherein the force receiving end of the rotating block is connected to a bearing, the probe contacting end of the rotating block defines an inclined surface, and the inclined surface of the rotating block contacts the pressing shaft;
wherein the rotating block comprises a rotating stop block, and the rotating stop block is configured to limit the rotating block, so that the rotating block has a fixed pressing initial position.

16. A distance detection method, comprising:
applying external forces to a distance detection device to enable a slider thereof to move to drive a detector thereof to move, comprising:
applying the external forces in the same direction to the distance detection device to cause the slider to move to different preset positions, so as to change an extension length of the detector in an initial state at different preset positions,
performing distance detection by moving the detector at any of the preset positions, and changing the extension length of the detector at a current preset position, and
after the distance detection, returning the extension length of the detector to the extension length in the initial state at the current preset position.

17. The distance detection method according to claim 16, wherein under the external forces in the same direction on the distance detection device and an elastic force, the slider is moved to different preset positions to change the extension length of the detector in the initial state.

18. The distance detection method according to claim 16, wherein the distance detection method further comprises resetting the detector by applying an external force on the slider along a length direction thereof, and repeatedly moving the slider along the length direction thereof to perform distance detection.

19. A processing device, comprising:
a processing head configured to process a workpiece,
the distance detection device according to claim 1;
wherein the processing head is connected to the distance detection device, the distance detection device is configured to detect a distance between a processing surface of the workpiece and the distance detection device;
wherein a position of the processing head is adjusted to process the workpiece according to the distance between the processing surface of the workpiece and the distance detection device.

20. The processing device according to claim 19, wherein the processing device further comprises moving devices, and the moving devices are configured to drive the processing head to move in three dimensions;
wherein the moving devices comprise a Z-axis moving device, a movable block is disposed on the Z-axis moving device, the movable block moves with the processing head, a pressing assembly is disposed on one side of the processing head, and the pressing assembly only moves with the processing head in an X-axis direction and a Y-axis direction;
wherein when the processing head moves in a Z-axis direction, the pressing assembly applies a force to the pressing shaft, a sensing assembly is disposed in the processing head, and the sensing assembly is configured to detect a state of the detector.
